(19) United States
(12) Patent Application Publication
(10) Pub. No.: US 2022/0109810 A1
(43) Pub. Date: Apr. 7, 2022

(54) DYNAMIC VIDEO CONFERENCE GENERATION AND SEGMENTATION

(71) Applicant: True Shape Inc., Marietta, GA (US)

(72) Inventors: Piyush Kancharlawar, Marietta, GA (US); Carl Liu, Marietta, GA (US); Chris Cherian, Marietta, GA (US); Khyati Shah, Marietta, GA (US)

(21) Appl. No.: 17/065,181

(22) Filed: Oct. 7, 2020

(51) Int. Cl. H04N 7/15

(52) U.S. Cl. CPC H04N 7/157

(57) ABSTRACT

A field can be generated with a first avatar at a first current position and a second current avatar at a second position. The first avatar can be associated with a first computing device. Similarly, the second avatar can be associated with a second computing device. Inputs on the computing devices can be used to adjust the current positions of the avatars. A distance between the avatars can be determined. If the distance between the avatars is less than or equal to a predetermined threshold, a multi-media conference can be initiated including the first and second computing device.

### TECHNICAL FIELD

The present systems and processes relate generally to digital conference generation and management.

### BACKGROUND

Previous approaches to digital conferencing are typically invitation- or link-based; however, such approaches may demonstrate several drawbacks. For example, previous systems may artificially and undesirably limit an audience size because attendees of the digital conference may be limited to only those who have been directly provided with an invitation. As another example, link-based systems may limit the ability to communicate with audiences on an ad-hoc basis because potential attendees who are not provided with a link to a video conference may be otherwise incapable of discovering and/or accessing the video conference. Furthermore, previous systems for digital conferencing may be host-dependent, which potentially imposes an unnecessary finality on digital conferencing sessions. For example, following a conclusion of their remarks, a presenter may suspend a video conferencing session. In this example, however, the suspension of the conferencing session may prevent participants from engaging in conversations with each other due to the loss of the presenting user's connection. In the same example, during the presenter's remarks, participants may be unable to share candid remarks and feedback with each other because such remarks may be undesirably accessible to the presenting user.

Therefore, there is a long-felt but unresolved need for a system or process that allows for dynamic and discoverable segmentation.

### BRIEF SUMMARY OF THE DISCLOSURE

Briefly described, and according to one embodiment, aspects of the present disclosure generally relate to systems and processes for generating and controlling digital conferencing sessions, such as video conferences.

A system for generating and controlling digital conferencing sessions can include a computing environment in communication with a plurality of computing devices over a network. Each of the plurality of computing devices can be associated with a user account, such as a conference presenter, representative, participant, etc. The computing environment can include a session service configured to generate virtual environments (referred to as “spatial fields”) in which digital avatars associated with the user accounts can be rendered. The avatar can be moved throughout the spatial field and can interact with other avatars and various regions of the spatial field, such as waypoints, exits, etc. The navigation of the avatar can be controlled via inputs to a session application running on the computing device. In response to one or more movements of the various avatars, the session service and/or session application can perform various actions.

The session service can determine that a proximity (e.g., a distance on a field) between two or more avatars meets a predetermined threshold. The session service can initiate a digital conference session (referred to as a “session”) that includes the two or more avatars (e.g., and the users associated therewith). Initiating the session can include causing a user interface to be rendered on computing devices associated with the avatars and causing video and/or audio streams of the computing devices to be shared. The session can be sustained based on the proximity threshold-satisfying position of the avatars. In response to a particular avatar moving beyond the proximity threshold, the avatar can be removed from the session, thereby suspending transmission of video and/or audio feeds to the computing device associated therewith. The session service can dynamically generate, update, and suspend a plurality of sessions based on movements of avatars throughout one or more spatial fields. The session service or session application can render a navigation interface comprising an overview of a spatial field. The navigation interface can include, for example, a map of a spatial field, locations of sessions and other avatars, a count of avatars within the spatial field and/or each session, and topics with which the spatial field and/or sessions are associated. In at least one embodiment, the navigation interface can include a color code for indicating various aspects of the sessions and avatars, such as associated topics, ability to engage, etc.

Within a session or spatial field, various processes can be initiated, such as a focus emulation process. A session or spatial field can be locked or paused to prevent admission of additional avatars and/or to allow for removal of avatars. A session or spatial field can be “muted,” causing video and/or audio feeds associated with avatars within the session to be suspended. In one example, a user broadcasts a video feed to everyone in a spatial region field. A selection can be received for a sub-region to which the user desires to focus their digital “attention.” Based on the selection, a user interface associated with the broadcaster is updated to include only video feeds of users associated with avatars within the sub-region. The sub-region can be updated automatically (e.g., based on an algorithm, pseudorandom seed, etc.) or in response to additional selections, thereby emulating the effect of scanning across a crowd (e.g., similar to a physical presenter scanning across an audience while presenting a speech).

A secondary session can be generated including a subset of avatars and associated user accounts/computing devices that are currently admitted to the same session. The secondary session can include, for example, a secondary video conference, chatroom, messaging group, etc. The secondary session can provide users a platform for observing each other's reactions and for discussing and commenting on the content of the primary session (e.g., without disturbing other session participants, such as a presenter). A session or secondary session can be monetized. For example, admission to a session can include processing payment of a onetime fee. In another example, continued participation in a session can be billed (e.g., on a time basis, interaction basis, etc.). In another example, a presenting user can be billed for each avatar that passes within a predetermined proximity of an associated session and/or for each avatar that enters a spatial field in which the session is located.

According to a first aspect, a system, comprising: A) a data store; and B) at least one computing device in communication with the data store, the at least one computing device being configured to: 1) receive, from a first computing device associated with a first avatar, a first request to join a field; 2) receive, from a second computing device associated with a second avatar, a second request to join the field; 3) generate the field comprising the first avatar at a first current position and the second avatar at a second current position; 4) adjust at least one of the first current position or the second current position in response to at least one input from at least one of the first computing device and the second computing device; 5) determine a distance between the first current position and the second current position is less than or equal to a threshold distance; and 6) in response to the distance being less than or equal to, initiate a session of a multi-media conference comprising at least the first computing device and the second computing device.

According to a further aspect, the system of the first aspect or any other aspect, wherein the at least one computing device is configured to: A) generate the field excluding the first avatar and the second avatar; B) update the field to include the first avatar responsive to the first request; and C) update the field to include the second avatar responsive to the second request.

According to a further aspect, the system of the first aspect or any other aspect, wherein the at least one computing device is configured to generate a visual representation of the multi-media conference on the field.

According to a further aspect, the system of the first aspect or any other aspect, wherein the at least one computing device is configured to: A) receive, from a third computing device associated with a third avatar, a third request to join the field; B) update the field to include the third avatar responsive to the third request; and C) in response to the third avatar moving to at least partially intersect with the visual representation of the multi-media conference on the field, add the third computing device to the session of the multi-media conference with at least the first computing device and the second computing device.

According to a further aspect, the system of the first aspect or any other aspect, wherein the at least one computing device is further configured to: A) adjust the first current position in response to a second at least one input from the first computing device; B) determine that the first current position is outside of at least a portion of the visual representation of the multi-media conference on the field; and C) remove the first computing device from the session of the multi-media conference.

According to a further aspect, the system of the first aspect or any other aspect, wherein the visual representation comprises a first visual representation and a second visual representation, the first visual representation occupying a greater portion of the field than the second visual representation, wherein the at least one computing device is further configured to: A) cause the field to be rendered with the first visual representation for a first plurality of computing devices in the session of the multi-media conference; and B) cause the field to be rendered with the second visual representation for a second plurality of computing devices that are not in the session of the multi-media conference.

According to a further aspect, the system of the first aspect or any other aspect, wherein the field comprises a third avatar at a third current position and a fourth avatar at a fourth current position, the third avatar is associated with a third computing device, the fourth avatar is associated with a fourth computing device, and the at least one computing device is further configured to: A) adjust at least one of the third current position or the fourth current position; B) determine a second distance between the third current position and the fourth current position is less than or equal to the threshold distance; and C) initiate a second multi-media conference session comprising at least the third computing device and the fourth computing device.

According to a second aspect, a method, comprising: A) generating, via at least one computing device, a field comprising a first avatar associated with a first computing device at a first current position and a second avatar associated with a second computing device at a second current position; B) adjusting, via the at least one computing device, at least one of the first current position or the second current position in response to at least one input from at least one of the first computing device and the second computing device; C) determining, via the at least one computing device, a distance between the first current position and the second current position is less than or equal to a threshold distance; and D) initiating, via the at least one computing device, a session of a multi-media conference comprising at least the first computing device and the second computing device.

According to a further aspect, the method of the second aspect or any other aspect, comprising receiving, via the at least one computing device and from the first computing device, a request to join the field, wherein the first avatar is added to the field in response to the request.

According to a further aspect, the method of the second aspect or any other aspect, wherein the field comprises a plurality of two-dimensional spatial fields.

According to a further aspect, the method of the second aspect or any other aspect, wherein the distance between the first current position and the second current position comprises two-dimensional distance between two points on a particular one of the plurality of two-dimensional spatial fields.

According to a further aspect, the method of the second aspect or any other aspect, further comprising generating a user interface comprising a visual representation of the plurality of two-dimensional spatial fields.

According to a further aspect, the method of the second aspect or any other aspect, further comprising: A) determining, via the at least one computing device, that the first current position is outside of a threshold area associated with the multi-media conference on the field; B) removing, via the at least one computing device, the first computing device from the session of the multi-media conference; C) determining, via the at least one computing device, that the first current position has moved within the threshold distance of a third avatar associated with a third computing device; and D) initiating, via the at least one computing device, a second session of a second multi-media conference comprising at least the first computing device and the third computing device.

According to a third aspect, a non-transitory computer-readable medium embodying a program that, when executed by at least one computing device, causes the at least one computing device to: A) generate a field comprising a first avatar at a first current position and a second avatar at a second current position, where the first avatar is associated with a first computing device and the second avatar is associated with a second computing device; B) adjust at least one of the first current position or the second current position in response to at least one input from at least one of the first computing device and the second computing device; C) determine a proximity of the first current position and the second current position is within a proximity threshold; and D) initiate a session of a multi-media conference comprising at least the first computing device and the second computing device.

According to a further aspect, the non-transitory computer-readable medium of the third aspect or any other aspect, wherein the program further causes the at least one computing device to generate a broadcast multi-media conference on an area of the field, wherein the broadcast multi-media conference comprises an audio feed and a video feed from a third computing device that is broadcast to a plurality of computing devices in the broadcast multi-media conference.

According to a further aspect, the non-transitory computer-readable medium of the third aspect or any other aspect, wherein the area of the field comprising the first current position and the second current position, and the program further causes the at least one computing device to transmit the video feed and the audio feed to at least the first computing device of the plurality of computing devices and the second computing device of the plurality of computing devices.

According to a further aspect, the non-transitory computer-readable medium of the third aspect or any other aspect, wherein the session of the multi-media conference comprising at least the first computing device and the second computing device occurs at least partially concurrent with the broadcast multi-media conference.

According to a further aspect, the non-transitory computer-readable medium of the third aspect or any other aspect, wherein the program further causes the at least one computing device to generate a user interface comprising the field and a plurality of visual representations individually corresponding to a plurality of multi-media conferences, where each of the plurality of visual representations is located on the field at a respective position.

According to a further aspect, the non-transitory computer-readable medium of the third aspect or any other aspect, wherein the program further causes the at least one computing device to: A) determine that a third current position of a third avatar associated with a third computing device moves to at least partially intersect with a visual representation of the multi-media conference on the field; B) determine that the multi-media conference is locked from accepting new participants; and C) prevent the third computing device from joining the session of the multi-media conference when the third current position moves to at least partially intersect with the visual representation and the multi-media conference is locked.

According to a further aspect, the non-transitory computer-readable medium of the third aspect or any other aspect, wherein the program further causes the at least one computing device to: A) determine that a third current position of a third avatar associated with a third computing device moves to at least partially intersect with a visual representation of the multi-media conference on the field; and B) generate a signal to at least one participant of the multi-media conference requesting approval to join the multi-media conference.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIGS. 1A-D show exemplary spatial field according to one embodiment of the present disclosure.

FIG. 2 is an exemplary networked environment according to one embodiment of the present disclosure.

FIG. 3 is a flowchart of an exemplary session generation process according to one embodiment of the present disclosure.

FIG. 4 is a flowchart of an exemplary focus emulation process according to one embodiment of the present disclosure.

FIGS. 5A-C show exemplary spatial fields according to one embodiment of the present disclosure.

FIGS. 6A-B show exemplary user interfaces according to one embodiment of the present disclosure.

FIGS. 7A-B show exemplary spatial fields according to one embodiment of the present disclosure.

FIGS. 8A-B show exemplary navigation interfaces according to one embodiment of the present disclosure.

FIGS. 9A-9B show exemplary user interfaces according to one embodiment of the present disclosure.

FIG. 10 shows exemplary user interfaces according to one embodiment of the present disclosure.

FIGS. 11A-11B show exemplary user interfaces according to one embodiment of the present disclosure.

FIGS. 12A-12B show exemplary user interfaces according to one embodiment of the present disclosure.

FIGS. 13A-13B show exemplary user interfaces according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

As used herein, “session” generally refers to an online communication session, such as, for example, a video conference or audio chat.

As used herein, a “premium” session generally refers to a session in which admittance requires payment. In one example, a premium session is a video conference requiring payment of a one-time or time-based admittance fee to obtain or maintain access.

As used herein, “spatial field” or “field” generally refers to a digital environment rendered as a 2-D or 3-D virtual area in which avatars may navigate and interact. A spatial field can include a 2-D or 3-D coordinate plane. For example, a spatial field can include X, Y, and Z planes. In this example, avatars can navigate in X- and Y-directions throughout a first floor located at a first point on a Z-axis. In the same example, the avatars can navigate to a second floor located at a second point on the Z-axis. Movement of avatars to particular regions of a spatial field, such as particular floors, can be restricted. For example, a three-floor spatial field can include a first and a second floor that is freely navigable to all avatars. In the same example, a third floor can be restricted to avatars associated with administrative users. A spatial field, or a sub-section thereof, can be premium-based, thereby requiring payment of a fee to access the spatial field. Spatial fields can include virtual structures such as rooms, halls, access points (e.g., virtual kiosks, elevators, waypoints, room thresholds, etc.). In addition to accessing dynamically generated sessions based on an avatar position, users may access predetermined sections of spatial fields to join preconfigured sessions.

### Overview

Aspects of the present disclosure generally relate to generation and management of digital conferencing sessions.

### Exemplary Embodiments

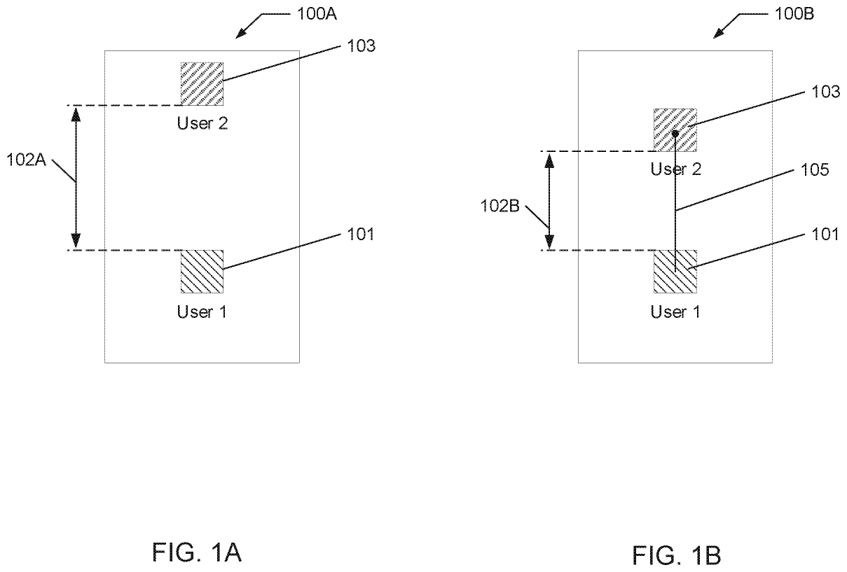

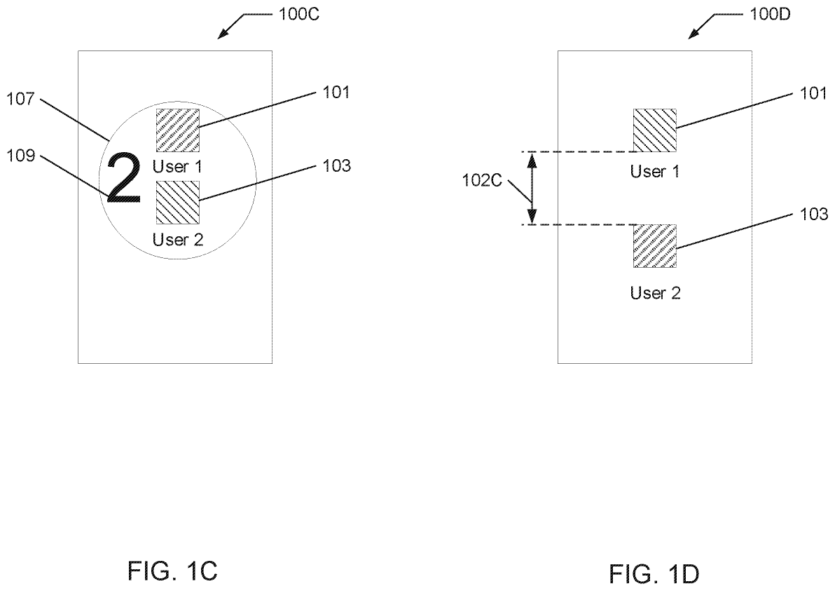

Referring now to the figures, for the purposes of example and explanation of the fundamental processes and components of the disclosed systems and processes, reference is made to FIG. 1A, which illustrates an exemplary spatial field 100A. As will be understood and appreciated, the exemplary spatial field 100A shown in FIG. 1A represents merely one approach or embodiment of the present system, and other aspects are used according to various embodiments of the present system.

FIG. 1A shows an exemplary spatial field 100A according to one embodiment. For the purposes of illustration and description, various spatial fields are described herein using a plurality of callouts and designators. It will be understood and appreciated that, in various embodiments, one or more aspects of the described spatial fields may be combined and any suitable combination of the disclosed spatial field features is contemplated. The description of a particular embodiment of a spatial field is not intended to limit elements of additional embodiments discussed herein.

The spatial field 100A can include a plurality of avatars. According to one embodiment, the spatial field 100A includes a first avatar 101 and a second avatar 103. Each avatar can be associated with a different user account and/or a computing device and can be controlled by a user (not shown) via the computing device, such as a laptop computer, smartphone, and etc. Identifying information for each avatar can be displayed within the spatial field. For example, each avatar can include a name associated with the corresponding user account, such as a username, nickname, credential, etc.

For the purposes of illustration and description, the following paragraph provides a non-limiting and exemplary scenario of activities occurring in the spatial field 100A (e.g., and in a computing environment by which the spatial field 100A is generated). The first avatar 101 and second avatar 103 are at a particular distance 102A. Each user (not shown) in control of the respective avatars 101, 103 is presented with a video conference. Each user can be presented with separate video conferences. In one example, each user is presented a separate video conference based on a determination that the particular distance 102A does not meet a predetermined threshold. On a display, each user may observe the position of their corresponding avatar and other avatars present in the spatial field 100A.

FIG. 1B shows an exemplary spatial field 100B, which may be similar to and temporally subsequent to the spatial field 100A. The first user can input a command to navigate the first avatar 101 throughout the spatial field 100B. For example, a command can be received to move the first avatar 101 toward the second avatar 103. A marker 105 rendered on the spatial field 100B can visually indicate the navigation command and/or motion path of the avatar 101.

Following the execution of the navigation command, the first avatar 101 and second avatar 103 are at a particular distance 102B from each other. Based on a determination that the particular distance 102B satisfies a predetermined threshold (e.g., is less than or equal to a predetermined threshold), the system can generate and present a new video conference to each of the corresponding users. In some embodiments, a particular user within a session is designated as a “presenting user.” A presenting user can be a user that initiated a session (e.g., based on a command, a movement, a predetermined schedule, etc.) or a particular user that is designated by other session-participating users. In some embodiments, the system can automatically designate a presenting user, for example, based on a predetermined schedule, a pseudorandom seed, or an input from the user (e.g., a selection on a user interface or spoken audio from the user). In at least one embodiment, the system can dynamically scale a predetermined threshold for controlling session admission. For example, a first predetermined threshold for generating a session comprising two avatars can be a first magnitude. In this example, upon generating the session, the system can generate a second predetermined threshold for admitting additional avatars that is greater than the first predetermined threshold. In the same example, following admission of at least one additional user, the second predetermined threshold can be increased such that a boundary of the session is increased.

FIG. 1C shows an exemplary spatial field 100C, which may be similar to and temporally subsequent to the spatial field 100B. The system can generate a session indicator 107 around the first avatar 101 and second avatar 103. The session indicator 107 can provide a visual indication of the “session,” (e.g., video conference) in which the avatars are participating. The system can size the session indicator 107 based on a predetermined threshold for controlling session admission. In one example, as the predetermined threshold is increased (e.g., in response to admission of additional avatars), the system can expand the session indicator 107 to indicate the increased threshold. The system can render a counter 109 in the spatial field 100C that represents a number of avatars or users within a session. In one example, for the session comprising the first avatar 101 and second avatar 103, the system can display the counter 109 with a value of “2.” The counter 109 can be visible to users whose corresponding avatars are not currently within a session or are within a separate session. In some embodiments, rules may define information associated with a session that is publicly displayed. For example, based on a privacy rule, usernames or other identifying indicia not may be displayed alongside corresponding avatars. In some embodiments, additional indicia describing elements of a session can be displayed. In one example, the system can render a “lock” symbol near the session indicator 107 and can indicate that admission to the corresponding session is prevented or limited, or requires approval of a presenting user. In another example, the system can render a “$” symbol or other currency symbol to indicate that admission to the corresponding session requires payment.

FIG. 1D shows an exemplary spatial field 100D, which may be similar to and temporally subsequent to the spatial field 100C. The second user can input a command to navigate the second avatar 103 throughout the spatial field 100D. For example, the system can receive a command to move the second avatar 103 away from the first avatar 101. The command can be received from a computing device associated with the second avatar 103. Following the execution of the navigation command, the first avatar 101 and second avatar 103 are at a particular distance 102C. Based on a determination that the particular distance 102C satisfies a predetermined threshold, the system can terminate the session. For example, the system can suspend the shared video conference presented to each user and present a separate video conference to each user.

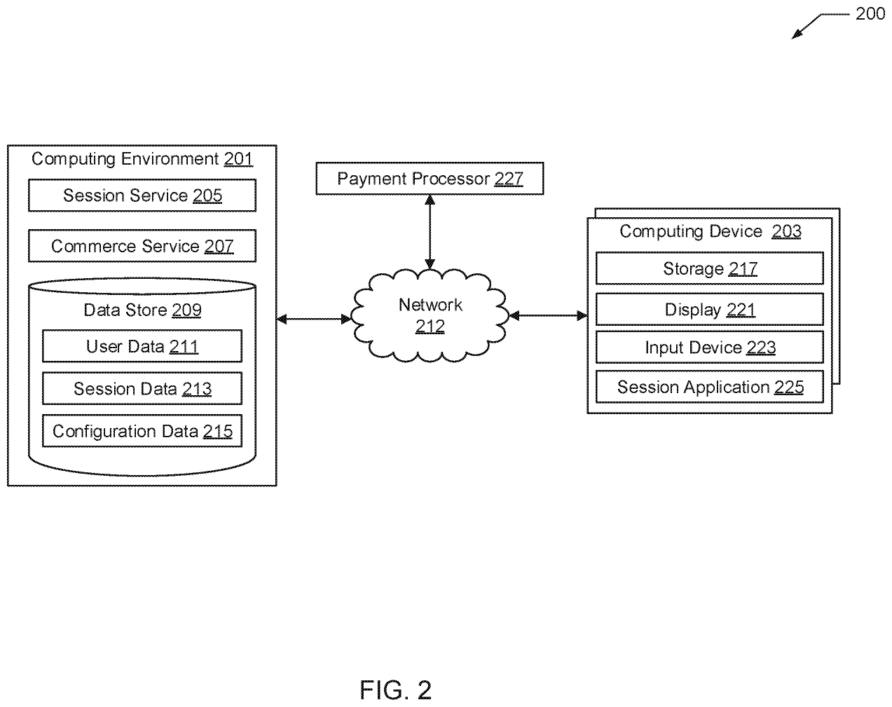

With reference to FIG. 2, shown is an exemplary networked environment 200 by which various processes are executed according to one embodiment. The networked environment 200 can include a computing environment 201 and one or more computing devices 203 in communication via a network 212. In some embodiments, a first computing device 203 communicates with the computing environment 201 over a first network 212 and a second computing device 203 communicates with the computing environment 201 over a second network 212. The network 212 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The elements of the computing environment 201 can be provided via a plurality of computing devices that may be arranged, for example, in one or more server banks or computer banks or other arrangements. Such computing devices can be located in a single installation or may be distributed among many different geographical locations. For example, the computing environment 201 can include a plurality of computing devices that together may include a hosted computing resource, a grid computing resource, and/or any other distributed computing arrangement. In some cases, the computing environment 201 can correspond to an elastic computing resource where the allotted capacity of processing, network, storage, or other computing-related resources may vary over time.

The computing environment 201 can include a session service 205, a commerce service 207, and a data store 209. The data store 209 can store various data related to processes and activities occurring throughout the networked environment 200, including, but not limited, user data 211, session data 213, and configuration data 215. The data store 209 can be representative of a plurality of data stores 209 as can be appreciated. In some embodiments, one or more of the user data 211, session data 213, and configuration data 215 are stored in storage 217, for example, on the computing device 203.

The user data 211 can include various data associated with one or more user accounts and user preferences. The user data 211 can include information describing the user, such as demographic factors, a current location, and user interests. The user data 211 can include credentials (e.g., username, password, etc.) for a user account, an avatar representing a user associated with the user account, and a plurality of settings, such as visibility, security, and payment-related settings. In one example, user data 211 includes a visibility setting that causes an avatar to be rendered (e.g., in a spatial field 100) without a username or with a predetermined nickname. In another example, user data 211 includes payment processing data that may be used to process payments for session admittance or generation. In another example, user data 211 includes a time-series record of sessions in which a particular user account participated. In this example, the time-series record can include a list of user accounts with which the particular user interacted, a mapping of an associated avatar's navigation throughout a spatial field, a chat history, and a duration value corresponding to an amount of time in which the particular user participated in one or more sessions. In some embodiments, the user data 211, or a subset thereof, is stored in an encrypted format. For example, personally identifiable information (PII) associated with the user can be encrypted such that access thereto requires a dual-authentication process, authentication of a public-private key pair, and/or other security measures.

The session data 213 can include historical data associated with previous sessions including, but not limited to, time and date, session duration, participants, revenue data (e.g., for a monetized session), chat histories, session recordings, and avatar data (e.g., avatar groupings, demographic data, time of entry, time of exit, etc.). In one example, session data 213 includes a list of usernames or user accounts that participated in a particular session. In this example, the list comprises a time-series log of participating user accounts, a level of engagement of the user (e.g., an attendance duration, chat history, and etc. associated with each user), and a revenue associated with each user account (e.g., based on fees collected for user admittance, user contributions, etc.). In another example, session data 213 includes a list of session sub-group that describes which of the one or more user accounts participated in one or more sub-groups during a particular session.

The configuration data 215 can include information associated with the generation and management of spatial fields and sessions (e.g., video conferences, chat sessions, etc.). The configuration data 215 can include settings for controlling session generation and admittance. In one example, configuration data 215 includes security settings for controlling admittance to a session. Security settings can include “public” (e.g., any avatar may move to and join a session), “private” (e.g., only pre-registered, pre-authorized, or password-entering avatars may join a session), and “monetized” (e.g., only avatars for which payment processing data has been received and authenticated may join a session). In one example, for a “private” setting, configuration data 215 includes a list of registered users that may be provided access to a particular session (e.g., an ongoing session or future session). The configuration data 215 can include predetermined thresholds for controlling session generation. For example, the configuration data 215 can include a distance threshold comprising a virtual distance value that, upon being satisfied by a computed distance between a first avatar and a second avatar, causes the initiation of a session comprising the first avatar and the second avatar.

The configuration data 215 can include descriptors, such as tags, that may be used to classify a spatial region or session. In one example, configuration data 215 for a sports-related spatial field includes a tag of “Sports.” In at least one embodiment, the session service 207 can update configuration data 215 of a spatial or session based on inputs from a user, such as one or more tags or other descriptors. The configuration data 215 can include images, documents, and media files that can be transmitted to a participant of a session automatically or in response to a command. In one example, configuration data 215 includes a multimedia brochure advertising a service, product, website, or personality. In this example, during a session, the multimedia brochure is rendered and/or transmitted in response to determining that a particular field has been selected.

The session service 205 can perform various actions, such as generating spatial fields, managing interactions of avatars within spatial fields, and generating sessions (e.g., based on user inputs and/or avatar interactions within spatial fields). In one example, the session service 205 generates a spatial field 100A (FIG. 1A) and facilitates the movement of avatars (e.g., such as avatars 101, 103) throughout the spatial field 100A. The session service 205 can track the virtual position of each avatar in virtually real time and can perform various actions based on the virtual position and/or user inputs. In one example, the session service 205 determines a proximity (e.g., a distance value) between a first avatar and a second avatar. In this example, the session service 205 compares the distance value to a predetermined threshold and performs one or more actions based on the comparison, such as initiating a video conference session comprising the users associated with the first and second avatars.

The session service 205 can dynamically generate, maintain, and suspend primary sessions and secondary sessions, for example, based on predetermined schedules, user inputs, and commands from the commerce service 207. A secondary session generally refers to a session corresponding to a sub-group of users that are concurrently participating in another session. In one example, a primary session includes a primary user, such as a presenter, and various secondary users that are attendees of the primary session. In the same example, in response to a request from one or more secondary users, the session service 205 generates a secondary session including a subset of the attending users and excluding the presenting user, thereby allowing for unmoderated critiques and discussion of the presenting user.

The session service 205 can host a web-page by which a spatial field 100 is accessed. In one example, a computing device 203 includes a session application 225 that accesses a particular web address at which a spatial field 100 is hosted. The session service 205 can host a plurality of spatial fields 100 concurrently. The session service 205 can control access to spatial fields 100 and to sessions initiated therewithin. For example, the session service 205 can enforce a credential policy requiring users to log in to a web-page, a spatial field 100, or a session. The session service 205 can restrict access to spatial fields 100 or sessions based on various networking information including, but not limited to, IP address, location, connection metrics (e.g., latency), age, language, and other factors. In one example, a spatial field 100 is restricted to users from New York City, N.Y. In this example, the session service 205 inspects IP addresses of each computing device 203 that requests access to the spatial field 100. In the same example, based on the IP addresses, the session service 205 determines a corresponding location of each computing device 203 and admits only those computing devices originating within New York City, N.Y. In another example, the session service 205 restricts access to a particular spatial field based on an email account associated with each user. In this example, the session service 205 permits access to the particular spatial field only to users that demonstrate an email account comprising a “.edu” extension.

The commerce service 207 can perform various actions, such as processing payment processing information, initiating transactions, and tracking billable activities performed by a user (e.g., or an avatar controlled thereby). For example, the commerce service 207 can determine that an avatar has navigated within a predetermined proximity of a premium session. In this example, the commerce service 207 can prompt the user to provide payment processing information and/or authorize a payment for accessing the premium session. Continuing this example, based on authentication of payment processing information and/or completion of a transaction, the commerce service 207 causes the session service 205 to admit the user.

The commerce service 207 can monitor traffic in a spatial field and can dynamically price and size sessions based on overall traffic or specific traffic. Overall traffic can refer to a total volume of users accessing a spatial field. Specific traffic can refer to a volume of users accessing a spatial field who demonstrate one or more predetermined qualities and/or perform one or more predetermined actions. In one example, specific traffic refers to a volume of users whose corresponding avatars pass by a particular section of a spatial field (e.g., the particular session being associated with a session-presenting user). In another example, specific traffic refers to a volume of users that accessed a particular session for a predetermined time period (e.g., at least 30 seconds, 1 minute, 5 minutes, etc.).

The commerce service 207 can track the consumption and scale of computing resources utilized to support a spatial field and/or sessions associated therewith. For example, the commerce service 207 can determine a storage, processor, and server-related metrics and, at least partially based on the determinations, can compute a computing resources fee that may be charged to a session-presenting user.

The computing device 203 can be any network-capable device including, but not limited to, smartphones, computers, tablets, smart accessories, such as a smartwatch, and other external devices. The computing device 203 can include a processor and storage 217 (e.g., memory, an external storage device, cloud-based storage, etc.). The computing device 203 can include a session application 225 that can access network-based environments hosted by the session service 205, such as spatial fields and sessions, as well as other network-based environments. The computing device 203 can include a display 221 on which various user interfaces can be rendered, such as, for example, spatial fields and session interfaces. The computing device 203 can include an input device 223 for providing inputs, such as requests and commands, to the computing device 202. The input device 223 can include a keyboard, mouse, pointer, touch screen, haptic feedback device, speaker for voice commands, camera or light sensing device to reach motions or gestures, or other input device.

The computing device 203 can include a session application 225 that can correspond to a web browser and a web page, a mobile app, a native application, a service, or other software that can be executed on the computing device 203. The session application 225 can display information, user interfaces, navigation interfaces, and pages, such as spatial fields and video conferences, associated with processes of the session service 205. The session application 225 can process inputs and transmit commands, requests, or responses to the computing environment 201 and to other computing devices 203. The storage 217 can store user data 211, session data 213, and/or configuration data 215. In one example, the storage 217 includes user preferences that control an appearance of the user's avatar and/or an interface presented to a user during navigation of a spatial field or interaction with a session.

The computing environment 201 and/or computing device 203 can communicate with a payment processor 227. The payment processor 227 can initiate and process transactions. For example, admission to a session can require payment of an admission fee and an avatar can be navigated within a predetermined proximity of the session. In this example, a user interface can be rendered comprising a field for approving payment of the admission fee. Continuing the example, in response to an input approving the payment, payment processing details can be transmitted to the payment processor 227. The payment processor 227 can transmit a confirmation indicating successful processing of a payment. For example, in response to processing payment for session admission, the payment processor 227 transmits a confirmation signal to the session service 207 comprising an identifier of the user account with which the payment is associated. In the same example, the session service 207 can admit the avatar to the session and cause a user interface associated therewith to be updated accordingly.

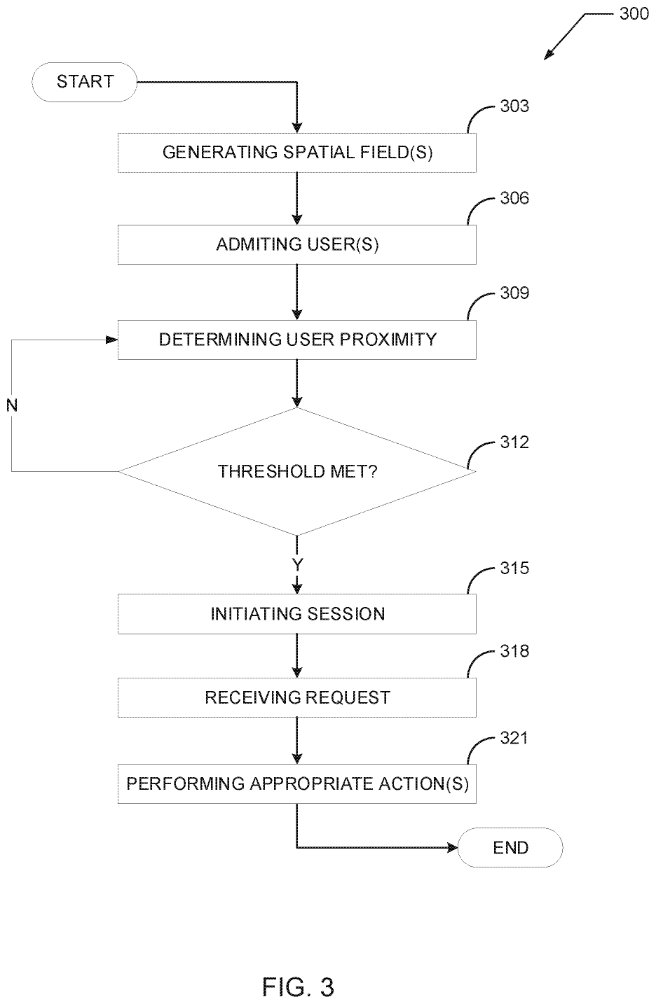

With reference to FIG. 3, shown is a session generation process 300 according to one embodiment. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown.

At step 303, the process 300 includes generating one or more spatial fields (e.g., such as the spatial field 100A shown in FIG. 1A). Generating the spatial field can include initiating a web page and generating a virtual environment that is accessible at a particular networking address. In one example, the spatial field is generated based on configuration data 215 comprising a predetermined layout. In this example, the spatial field is public (e.g., any user may access the field via a link) and comprises a plurality of predetermined regions based on the predetermined layout. In the same example, each region of the spatial field is associated with a particular primary user, such as a representative of a particular company. The session application 225 can access the spatial field (e.g., by accessing the field-hosting web page) and render the current state of the spatial field on the display 221 of the computing device 203.

In some embodiments, the session application 225 receives configuration data 215 from the session service 205 and renders a spatial field based on the configuration data. The configuration data 215 can include access policies, predetermined layouts, user identifiers, and current avatar locations (e.g., that can be represented as coordinates corresponding to particular locations within the spatial field). The session application 225 can transmit session data 213 (e.g., user inputs, avatar position, etc.) and receive updated configuration data 215 in a substantially continuous manner. In virtually real-time and for each user, the current state of the spatial field can be resolved by the session service 205, transmitted to the session application 225, and rendered on the computing device 203. In some embodiments, the session application 225 communicates with the session service 205 via an application programming interface (API).

At step 306, the process includes admitting one or more users to the spatial field. Admitting the user can include authenticating one or more user credentials, such as, for example, a username and password, location, IP address, etc. The session application 225 can access a login page and, upon admission of the user, can be redirected to a web-page at which the spatial field is hosted. In one example, the session application 225 transmits a user identifier and credentials, such as a password or public key, to the session service 205. The session service 205 can receive a request from one or more computing devices 203 to join a spatial field. Via comparisons to user data 211 and a public-private key pair, the session service 205 can authenticate the user identifier and credentials for the one or more computing devices 203. In the same example, the session application 225 is permitted access to the spatial field. The session service 205 can generate the spatial field that includes an avatar associated with each of the one or more authenticated computing devices 203. Upon being admitted to the spatial field, the display 221 can be updated to display a rendering of the spatial field, comprising the user's avatar and avatars of other users.

In some embodiments, upon admitting a user, one or more notifications are transmitted to the computing device 203 and/or are rendered within the spatial field. The notification can include, but is not limited to, a list of current users, a list of current sessions, a list of scheduled sessions, a map of the spatial field, and other information. The notification can be interactive and the session application 225 or session service 205 can update the spatial field based on inputs to the notification. In one example, the notification includes a list of current sessions and a user selects a particular session. In the same example, in response to the selection, the user's avatar is automatically placed into the particular session. In another example, the notification includes a map comprising a plurality of floors, each floor corresponding to a particular spatial field or sub-region thereof. In this example, a user selects one of the plurality of floors and, in response, the user's avatar is admitted to the selected floor (e.g., and the display of the spatial field is updated accordingly).

At step 309, the process 300 includes determining a user proximity. The current position of the user's avatar can be compared to the position of each other avatar in the spatial field and/or to a boundary of a session. In some embodiments, the avatar's distance to each other avatar is computed, for example, using a distance formula. In one example, a session indicator 107 (see FIG. 1C) defines a boundary of a session. In this example, a proximity between the avatar and the session boundary is computed. In various embodiments, the position comparison is constrained to those avatars within a field of view of the user's avatar.

At step 312, the process 300 includes determining if a predetermined threshold is met. The proximity of the user's avatar to another avatar and/or to a session boundary can be compared to a predetermined threshold. In response to determining that the predetermined threshold is not met, the process 300 can proceed to step 309. In response to determining that the predetermined threshold is met, the process 300 can proceed to step 315. In some embodiments, the proximity of the user's avatar can be compared to multiple predetermined thresholds. For example, the session service 205 can compare the proximity to a first session threshold and, in response to determining dissatisfaction of the first boundary threshold, the session service 205 can compare the proximity to a second boundary threshold that is greater than the first boundary threshold. In response to determining satisfaction of the second boundary threshold, the session service 205 can present an overview of the associated sessions to a user, the overview including one or more of a topic, a presenting user, a list of participating users, a fee associated with admission to the session, and other information. In some embodiments, session service 205 can adjust the predetermined threshold based on input from a host of a session or by a user in control of an avatar. For example, the user can select a lower threshold, thereby resulting in the initiation of a session at greater distances. In another example, a presenting user can select a lower boundary threshold such that avatars must come within closer proximity of a session boundary (e.g., denoted by a session indicator) before being admitted.

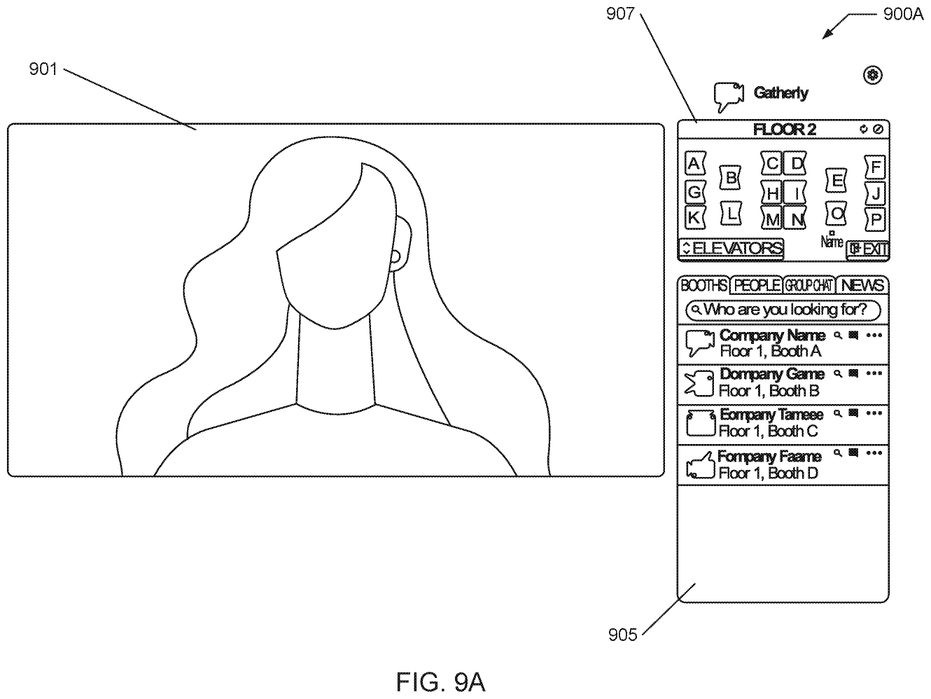

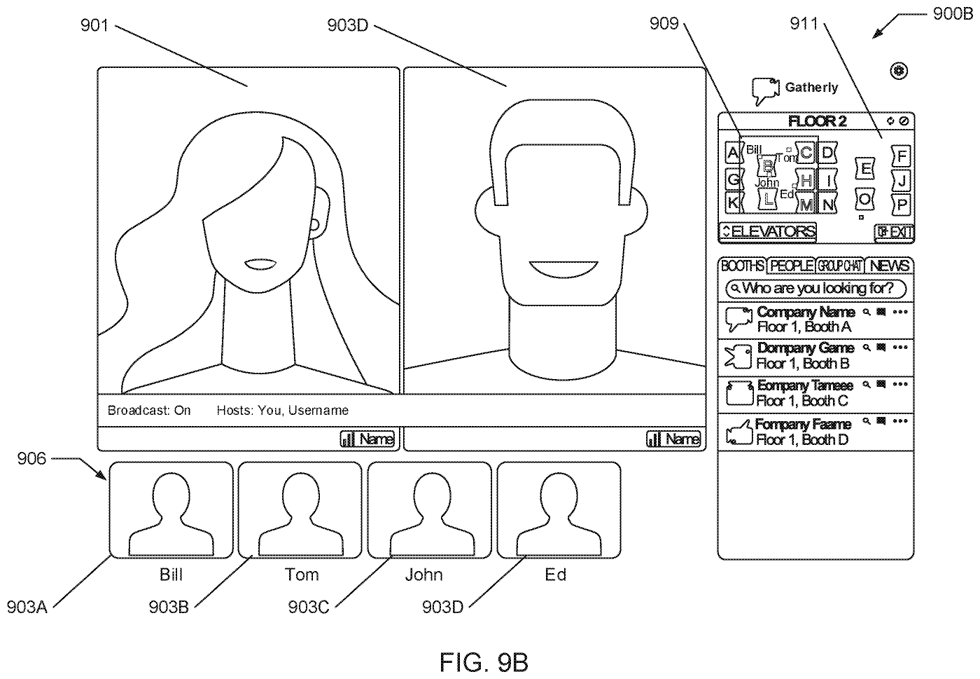

At step 315, the process 300 includes initiating a session. Initiating the session can include generating and/or accessing a particular network address at which a video conference is hosted. For the example, the session service 205 can transmit a network address to the session application 225, which logs into a video conference hosted at the network address. Initiating the session can include transmitting a network address to each of one or more users within a predetermined proximity (e.g., of each other or an in-progress session defined by a session boundary) such that the users are admitted to a session substantially simultaneously. Initiating the session can include receiving and processing video and/or audio feeds from the computing device 203 of each user. The video and/or audio streams can be transmitted to each user. For example, each video stream can be rendered within a user interface (e.g., for example, a user interface as shown in FIGS. 9A-13B).

In some embodiments, the session is initiated based on successful authentication of payment processing information. In one example, the session application 225 prompts a user to enter payment processing information. In this example, the session application 225 transmits the payment processing information (e.g., in an encrypted format) to the commerce service 207. Continuing the example, the commerce service 207 communicates with a payment processor 227 to authenticate the payment processing information and, in response to successful authentication, transmits a command to the session service 207 that causes admittance of the user to the session.

In at least one embodiment, the session service admits a user to a session based on a command from a session-presenting user and/or another user that is currently in the session. In one example, upon satisfying the predetermined proximity threshold, a user is presented with an interface by which they “knock” and request admission to the corresponding session. In this example, a notification is transmitted to the computing device 203 of the user for which the session was initially generated, the notification comprising fields for permitting or refusing admission to the requesting user. Continuing the same example, in response to a selection for providing permission, the requesting user is admitted to the session (e.g., and the display 221 is updated to include a session interface).

At step 318, the process 300 includes receiving a request. The request can be, for example, a request to initiate a secondary session (also referred to as a “subgroup”) comprising a subset of the users of the in-progress session. In another example, the request is to remove one or more users from the session or to report one or more users. In another example, the request is to “pause” or “lock” the session, thereby causing the session service 205 to prevent admission of other users into the session and/or render the session invisible within the spatial field (e.g., via removal of a session indicator, session-admitted avatars. In some embodiments, the session service 205 can authenticate a request to lock or pause a session based on user data 211 to determine that the requesting user is permitted to initiate the command. One or users in a session can be assigned administrator privileges. Administrator privileges can include one or more of, but are not limited to, locking or pausing the session, inviting additional users, establishing a price level for admission to or ongoing participation in the session, muting one or more audio feeds associated with the session, muting one or more video feeds associated with the session, and removing one or more users from the session.

In another example, the request is to “emulate focus” for a hosting or presenting user toward a subgroup of admitted users. In another example, the request is to navigate throughout the spatial field or to enter another spatial field. In another example, the request is invite one or more users to the in-progress session. In another example, the request is to “follow” or “subscribe” to the presenting user. In some embodiments, following or subscribing to a user can cause the subscribing-user to be alerted when the subscribed-to user initiates or is admitted to a session or a spatial field.

At step 321, the process 300 includes performing one or more actions based on the request. In one example, the session service 207 generates a secondary session comprising a subset of users from an in-progress (e.g., “primary”) session, the subset of users being included in the request. In this example, the session service 207 initiates the secondary session at a second network address or as a permissioned segment of the network address at which the primary session is hosted. Continuing this example, the session service 207 transmits a link to each of the users of the subset and, in response to a user selecting the link, admits each user to the secondary session. The session service 207 can generate a secondary session of a multi-media conference at least partially concurrent with a primary broadcast multi-media conference. The session of the multi-media conference may include a subset of user accounts currently viewing the broadcast multi-media conference.

In another example, the session service 207 locks the primary session. The session service 207 can suspend admission of additional users to the primary session and/or can update user interfaces of each user in the spatial field to exclude a session indicator and/or avatars of each admitted user. The session service 207 can mute an audio or video feed associated with the session or a spatial field. In one example, a user with admin privileges can pause a particular region of a spatial field (e.g., local muting) or an entire spatial field (e.g., global muting) such that users therein are unable to hear or observes sessions therein and are unable to initiate or join additional sessions.

The session service 207 can provide a presenting user or an administrative user with a list of currently admitted users (e.g., admitted to a particular session or particular spatial field). The session service 207 can receive a selection of one or more users and, for each selected user, revoke access to the particular session or particular spatial field. The session service 207 can transmit an alert to each of the selected users, the alert indicating the revocation of admission and, in some embodiments, providing a reason for revocation (for example, noncompliance with one or more rules, such as rules against inappropriate language).

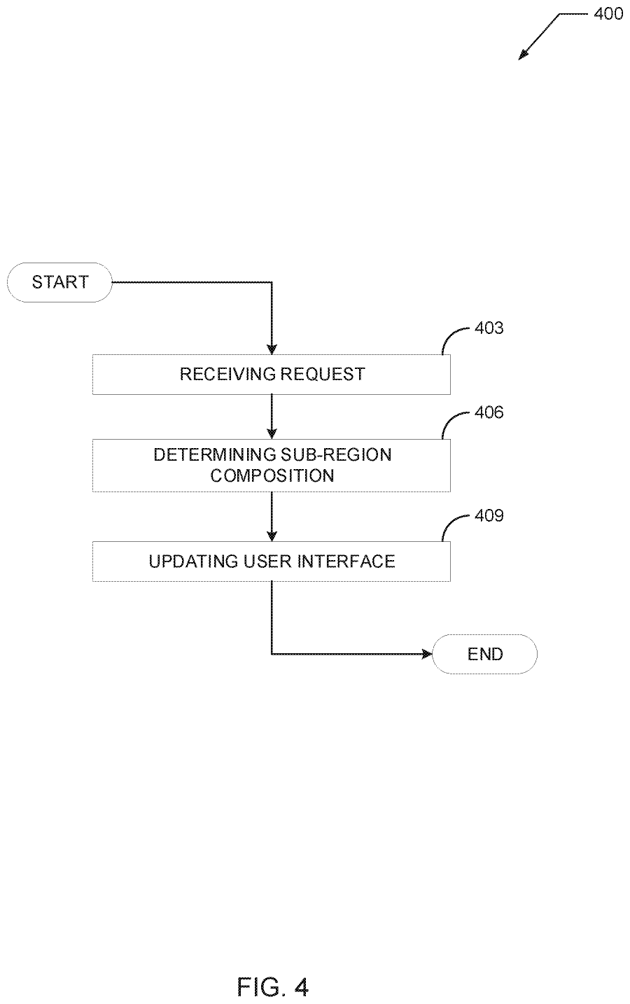

In another example, a focus emulation process (e.g., such as the session emulation process 400 shown in FIG. 4) is performed. In this example, user interfaces of a subset of admitted users are updated to include a video conferencing screen of a presenting user, thereby emulating an effect of a presenter scanning a crowd and focusing their attention on a particular subset of attendees.

In another example, the display 221 is updated to reposition an avatar from a current location (e.g., within the boundary of the current session) to a selected location. In this example, based on a user's selection or other navigation-related input, the session application 225 updates the display 221 to move the avatar from the current location to the second location. Continuing this example, the session service 205 or session application 225 removes the user from the current session, which may include terminating a video conference and/or exiting a web-page at which the session is hosted. In the same example, the user can be presented with a plurality of options for navigating to additional spatial fields and/or sessions.

In another example, an invitation is transmitted to one or more users. The invitation can include an identification of a user that requested transmission of the invitation, information associated with the current session, and a selectable field, such as a link, for requesting admission to the current session. The receiving user can provide an input accepting the invitation and, in response, the user can be admitted to the current session.

In another example, a participating user is subscribed to a presenting user (or another participating user). Subscribing to or following a particular user can include updating user data 211 associated with the subscribing user such that the subscribing user is notified when the particular user is in a session, in a spatial field, and/or is scheduled to be in a session or spatial field. In some embodiments, the session service 205 presents one or more options to the subscribing user, the options corresponding to controlling various aspects of the subscription. For example, the options can include notification methods and alert settings (e.g., such that the user is only alerted upon the particular user initiating a session). In another example, the options include an option for following the navigation of the subscribed-to user. In this example, the avatar of the subscribing user can automatically follow the avatar of the subscribed-to user such that the users participate in sessions as a grouping. In the same example, the session service 205 can restrict the navigation-following option to users that are mutually subscribed, which can be contingent upon approval from the subscribed-to user.

In one example, the subscription process includes transmitting a subscription request to the particular user, the subscription request comprising subscription approval and rejection options. In the same example, in response to receiving approval, the requesting user is subscribed to the particular user.

With reference to FIG. 4, shown is a focus emulation process 400. At step 403, the process 400 includes receiving or initiating a focus emulation request. In one example, the request is received from a presenting user. In another example, the request is automatically initiated based on a predetermined schedule, an algorithm, or on a pseudorandom basis. The request can be authenticated based on user credentials. For example, the request can include a user identifier that is compared to session data 213 or configuration data 215 to confirm that the associated user is permitted to initiate the process 400. The request can include a selection for a particular region (referred to as a “sub-region”) of a spatial field (e.g., occupied by a plurality of avatars) or one or more users (or avatars controlled thereby).

At step 406, the process 400 includes determining sub-region composition. Determining sub-region composition can include determining one or more users within a selected sub-region. In one example, determining sub-region composition includes computing a proximity of each user in the primary session to the selected sub-region and identifying users within a predetermined proximity. In another example, determining the sub-region composition includes generating a list of users based on a pseudorandom seed, the users comprising the list being included in the sub-region. In another example, an algorithmic process is executed to identify a subset of users for inclusion in the sub-region. The algorithmic process can analyze user data 211 and/or session data 213 of session-participating users to identify a particular group of users. For example, the algorithmic process can identify users who have not yet been included in a sub-region, or who demonstrate similar or dissimilar demographics, interests, or other factors.

At step 409, the process 400 includes updating a user interface. The user interface of the presenting user can be updated to include representations of each user of the sub-group. The representations can comprise a video feed, user account photo, username, avatar, or other information (e.g., based on user data 211). The user interfaces of users within the sub-region can be updated to indicate their designation as users within the sub-region. For example, the user interface of each user in the sub-region can be updated to include a video and audio feed from the presenting user. In this example, the updated user interfaces may emulate an in-person speaker's focusing of attention on a particular subset of an audience. In some embodiments, users within the sub-region can be presented with options to acknowledge or interact with the presenting user. For example, the users can be presented with options for causing their corresponding avatar to nod, wave, deliver a thumbs up, and etc. In another example, the users can be presented with a field for posing a question to the presenting user.

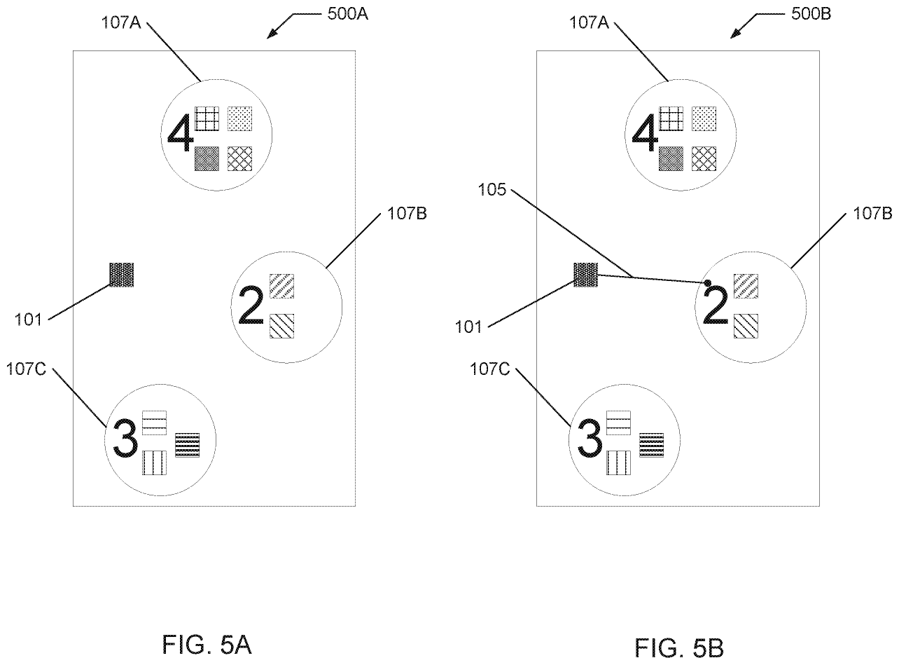

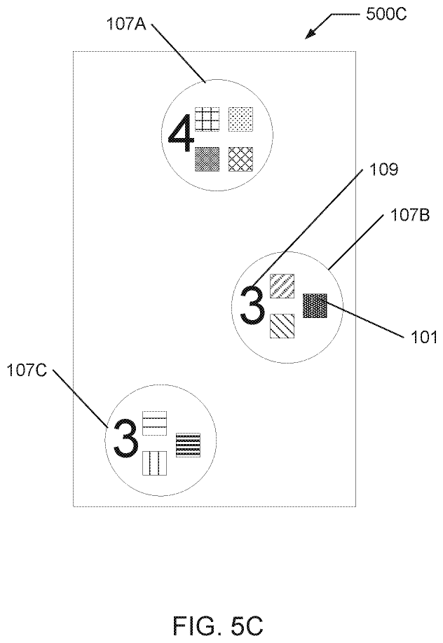

FIG. 5A shows an exemplary spatial field 500A according to one embodiment. The spatial field 200A can include an avatar 101 and one or more session markers 107A, 107B, 107C that indicate predefined and/or ongoing sessions to which the avatar 101 can navigate and join. The session service 205 can generate a user interface with the one or more secondary avatars (e.g., each associated with a different user) presented in the spatial field 100A. The avatars can traverse the spatial field 100A to participate in the various sessions. The session service 205 can move the avatars 101 around the spatial field 100A based on inputs/commands received from associated computing devices 203.

FIG. 5B shows an exemplary spatial field 500B. The spatial field 500B may be similar to and temporally subsequent to the spatial field 500A. The session service 205 can receive a command to navigate the avatar 101 to a particular session marker 107B. As an example, a user may press a key on a keyboard associated with a direction of travel, and the session service 205 can receive an indication from the session application 225 of the input, and the session service 205 can move the corresponding avatar 101 within the spatial field 500B based on the input. A marker 105 can indicate the command or motion path. When the avatar 101 crosses into a threshold distance from the particular session marker 107B, which may be when the avatar 101 is determined to have collided with the particular session marker 107B, the session service 205 can admit a computing device 203 associated with the avatar 101 into a session of a multi-media conference.

FIG. 5C shows an exemplary spatial field 500C. The spatial field 500C may be similar to and temporally subsequent to the spatial field 500B. The avatar 101 can be admitted to the session indicated by the session marker 107B. A session counter 109 can be incremented based on the admission of the avatar 101.

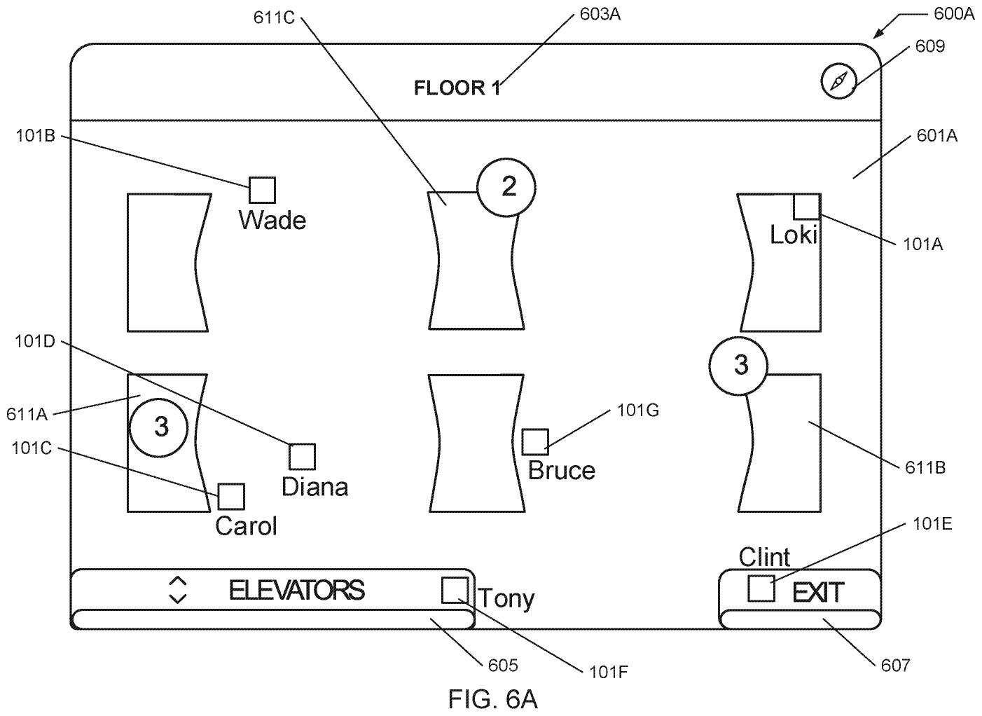

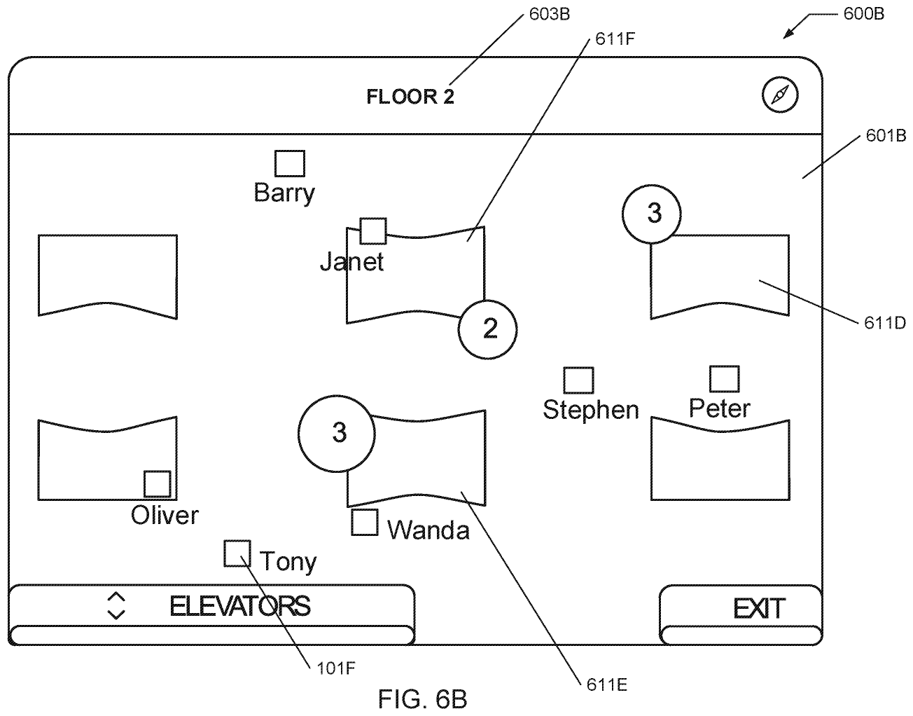

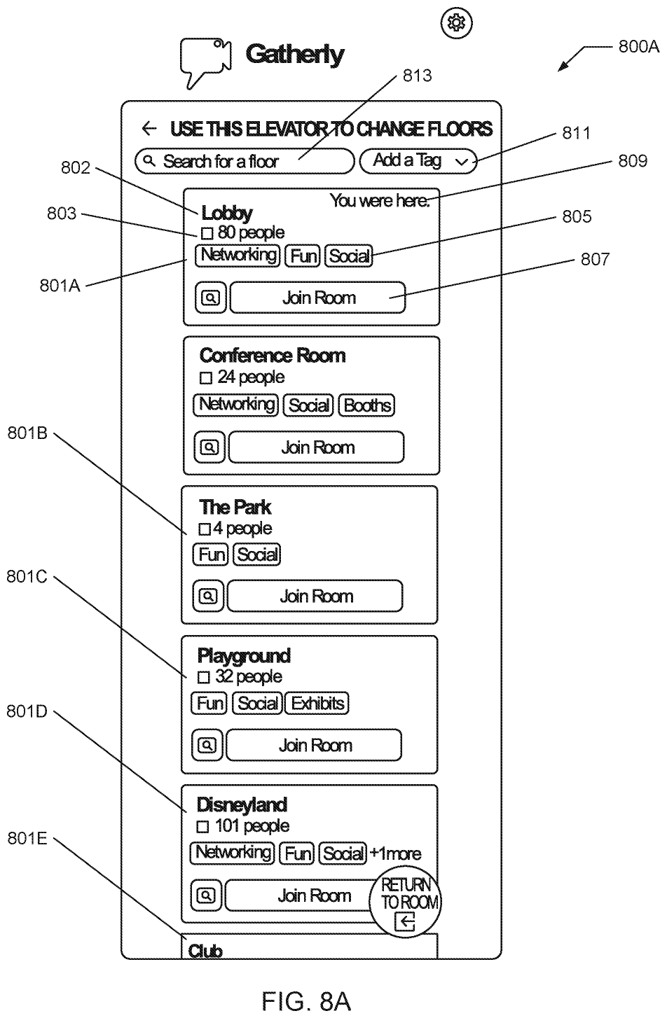

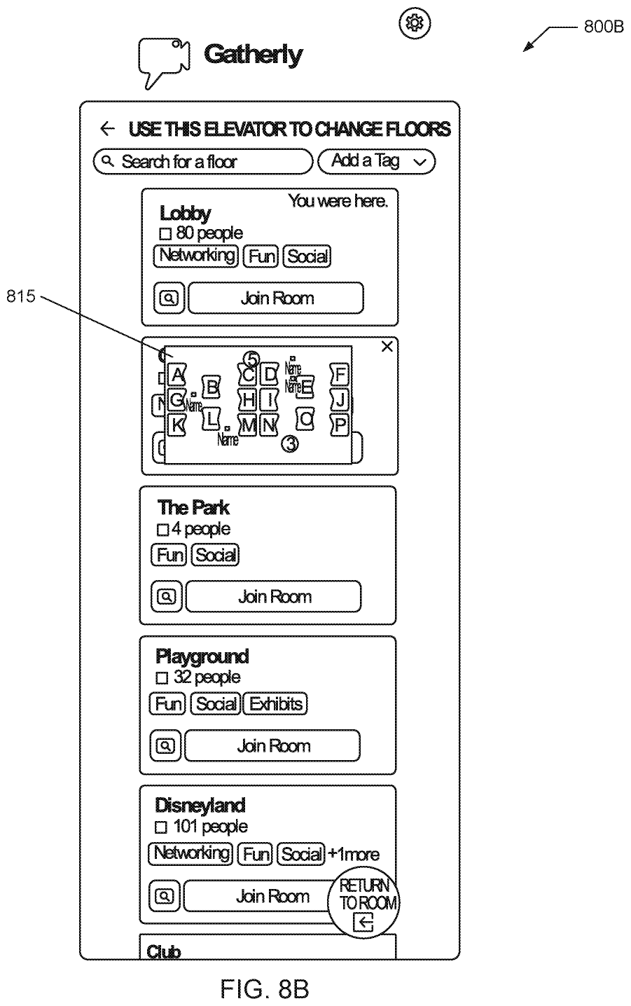

FIG. 6A shows an exemplary user interface 600A. The user interface 600A can be rendered on one or more computing devices 203 and may be generated by the session services 205. The user interface 600A can include a spatial field 601A within which various avatars 101A-G are displayed. The user interface 600A can include a title 603A associated with the spatial field 601A or a region thereof, such as a particular floor. The spatial field 600A can be separated into distinct regions, such as floors, rooms, etc. Users can navigate throughout various regions, for example, via a waypoint 605. When an avatar 101 traverses into a waypoint 605, the session service 205 can move the avatar to a region associated with the waypoint 605. The session service 205 can cause a corresponding computing device to be presented with a navigation interface (e.g., as shown in FIGS. 8A-B) in response to navigation of an avatar to a waypoint 605, by which the user may navigate the avatar to other regions and/or other spatial fields. In some embodiments, the session service 205 can restrict one or more users from particular regions or particular spatial fields, which can be determined based on one or more configuration parameters specified by a host or through other user interaction or preferences. For example, based on configuration data 215 and/or user data 211 (e.g., such as permissions), the session service 205 can prevent a user from accessing a second and third floor of a six-floor spatial field (e.g., each floor being a distinct region of the spatial field).

The spatial field 601A can include an exit 607 to which the avatar may be navigated. Selection of or navigation of an avatar to the exit 607 can cause the session service 205 to present a corresponding user with a navigation interface or can cause the session service 205 to terminate the user's connection to the session service 205. The user interface 600A can include a navigation tool 609, such as a virtual compass, that provides a user with navigational information for exploring the spatial field 601A. In some embodiments, the navigation tool 609 includes a mini-map and/or navigational instructions (e.g., for navigating an associated avatar to a particular session, region, spatial field, or other avatar). The navigation tool 609 can be continuously updated to direct a first user toward a second user to which the first user is subscribed or to a particular session for which the user has expressed interest (e.g., based on responding to a session invitation).

The spatial field 601A can include one or more session stations 611A, 611B, 611C. Each session station 611A, 611B, 611C can be associated with a particular user or entity. The following paragraph provides an exemplary scenario associated with the spatial field 601A, which can be facilitated by the session service 205 and the session application 225.

In an exemplary scenario, the spatial field 601A is generated as a digital conferencing environment for a comic book convention in which each session station 611A, 611B, 611C corresponds to a particular featured speaker. Users can navigate avatars throughout the spatial field 601A and users can navigate avatars 101C, 101D to the session station 611A to participate in a scheduled session in which a presenting speaker directs a question and answer activity. Admission to the session associated with the session station 611A may require prepayment, which can occur via authentication of payment processing data (e.g., as performed by a payment processor 227). Another user can navigate the avatar 101F to a waypoint 605 to access other portions of the convention, for example, a spatial field 600B (FIG. 6B). An additional user can navigate the avatar 101E to an exit 607, thereby suspending the user's session and causing the session application 225 to suspend activities or render another interface, such as a navigation interface.

FIG. 6B shows an exemplary user interface 600B. Based on a navigation command or selection, the session service 205 can cause the avatar 101F to enter a spatial field 601B. The spatial field 601B can include session stations 611D, 611C, 611D to which the avatar may be navigated. In one example, the avatar 101F is navigated to the session station 611E and is admitted to a session associated therewith. In the same example, the session is a screening of a trailer for an upcoming film and the avatar 101F can be admitted to a session sub-group in which reactions and feedback are shared.

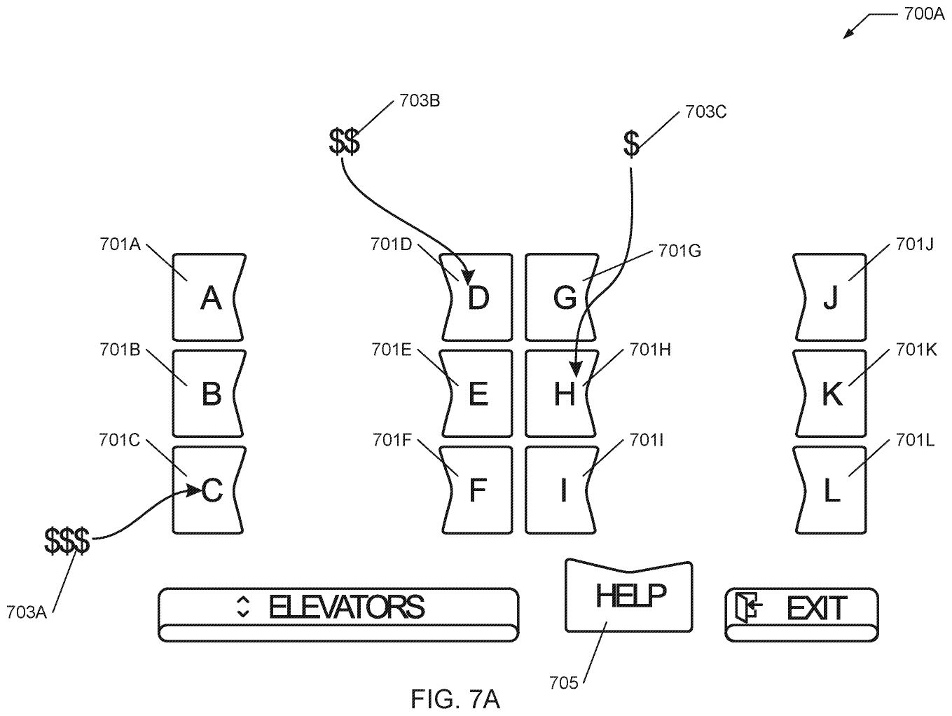

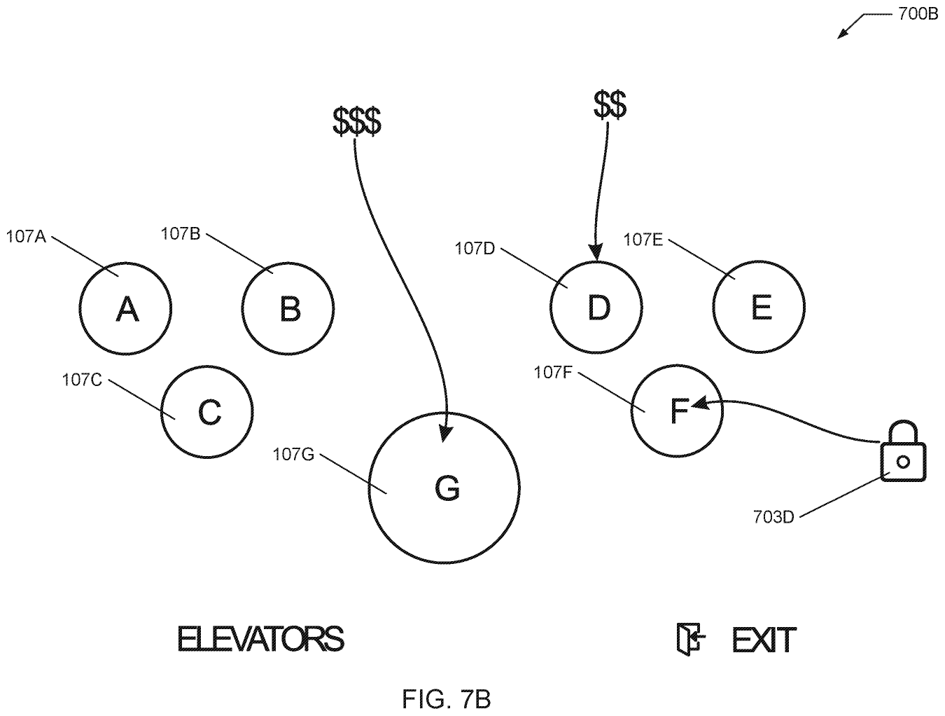

FIG. 7A shows an exemplary spatial field 700A. The spatial field 700A can include one or more session stations 701A-L. A subset of the session stations 701C, 701D, 701H can include indicia that indicate various aspects of the sessions associated therewith. In one example, the session station 701C includes indicia 703A comprising a series of currency symbols that indicate a relative price level for admission to a session with which the session station 701C is associated. In another example, the session station 701D includes indicia 703B comprising a shorter series currency symbols to indicate the relative price level of an associated session that is less costly compared to the session associated with indicia 703A. In another example, the session station 701H includes indicia 703C comprising a single currency symbol to indicate that an associated session costs less than the sessions associated with indicia 703A, 703B. The spatial field 700A can include a help station 705 that can be selected and/or to which an avatar can be navigated. Navigation to or selection of the help station 705 can cause a user to be presented with a help interface comprising various information associated with the spatial field 700A and elements therein, such as descriptions of the various indicia 703A, 703B, 703C or discrete price levels associated therewith.

FIG. 7B shows an exemplary spatial field 700B. The spatial field 700B can include a plurality of session indicators 107A-G. One or more of the session indicators 701A-G can include indicia indicating various session aspects. In one example, the session indicator 107F includes indicia 703D comprising a lock symbol, thereby indicating that access to the associated session is restriction and may be permission and/or invitation-based.

FIG. 8A shows an exemplary navigation interface 800A. The navigation interface 800A can be rendered upon navigation to a particular region of a spatial field (e.g., to a waypoint), or can be rendered alongside a spatial field (e.g., within the same) user interface. The navigation interface 800A can provide an overview of accessible spatial fields. The navigation field 800A can be rendered based on user data 211. For example, based on permissions and subscriptions stored in user data 211, the session service 205 can cause a particular navigation field 800A to be rendered that includes set of spatial fields to which the corresponding user has been provided access.

The navigation interface can include a plurality of summaries 801A-F. A summary can include one or more of, but is not limited to, titles 802, counters 803, tags 805, and selectable fields 807. The title 802 can provide an indication of a topic or themed with which the spatial field is associated. In one example, a title 802 is “Art Gallery,” thereby indicating the associated spatial field includes art-themed sessions. The counter 803 can indicate a total number of avatars or users within the corresponding spatial region. The tag 805 can provide an indication of topics or other elements with which the spatial region is associated. The selectable field 807 can be a link to access the spatial region or a particular session therewithin. In one example, in response to a selection of the selectable field 807, the session service 205 causes a more detailed spatial field interface to be rendered. In another example, responsive to selection of the selectable field 807, the session service 205 causes a spatial field and/or session to be rendered, the spatial field or session being one that is currently being accessed by the user's avatar. The summary can include an indicator 809 that indicates a user's previous admission to a spatial field or session with which the summary is associated. The indicator 809 can be rendered based on user data 211, such as a time-series log of the user's navigation commands.

For the purposes of indexing and discovering spatial fields and sessions, the navigation interface 800A can include a search tool 813. In one example, the search tool 813 receives an input for “Sports” and the navigation interface 800A is updated to include a plurality of spatial fields or sessions associated with the term “Sports.” The navigation interface 800A can include a field 811 for adding one or more tags to a summary. Inputs to the field 811 can be used to update corresponding configuration data 215 such that the inputted information is associated with a particular spatial field or session.

FIG. 8B shows an exemplary navigation interface 800B. The navigation interface 800B can be temporally subsequent and substantially similar to the navigation interface 800A (FIG. 8A). The navigation interface 800B can include a detailed interface 815. The detailed interface 815 can be rendered, for example, in response to a user selecting or placing a cursor (or other input tool) over a particular summary. The detailed interface 815 can include a rendering of a current state of a spatial field, thereby providing a summary of the layout thereof, ongoing sessions, and counts of participating users.

FIG. 9A shows an exemplary session interface 900A. In one example, an avatar is commanded to move within a predetermined proximity of a plurality of avatars. In the same example, the session interface 900A is rendered on a user's computing device 203. The session interface 900A can include a video feed 901 comprising a substantially real-time video conferencing feed of the user with which the avatar is associated. The session interface 900A can include one or more secondary video feeds 903A-D comprising video feeds of users with which other participating avatars are associated. The session interface 900A can include a navigation interface 905 that may be substantially similar to the navigation interface 800A, 800B (FIGS. 8A-B). The session interface 900A can include a detailed interface 907 that may be substantially similar to the detailed interface 815 (FIG. 8B).

FIG. 9B shows an exemplary session interface 900B. The session interface 900B can be rendered based on a focus emulation procession 400 (FIG. 4) that is initiated based on a command from the user associated with the video feed 901 (also referred to as a presenting or host user). For example, a selection of a sub-region 909 within a spatial field 911 can be received and the session service 207 can identify avatars within the selection. Secondary video feeds 903A-E associated with the users of the identified avatars can be displayed. Secondary video feeds can be included, for example, in a ribbon region 906 that may be oriented beneath the video feed 901. One or more secondary video feeds can be scaled to a greater dimension than dimensions of secondary video feeds within the ribbon region 906 (e.g., a dimension similar to a rendered dimension of the video feed 901) and the scaled feed can be oriented alongside the video feed 901. The scaling and reorientation of the secondary video feed can be performed automatically. In one example, an audio input comprising a spoken question is received from a computing device 203 with which the video feed 903E is associated. In the same example, the video feed 903E can be scaled upwards and oriented alongside the video feed 901, thereby simulating a question and answer dynamic between the associated users.

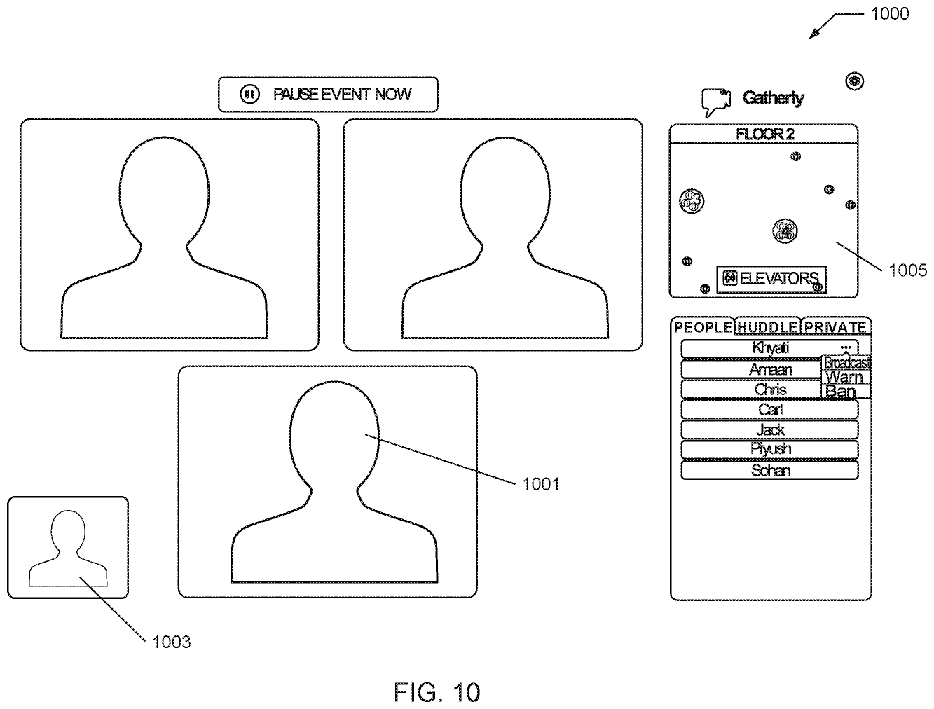

FIG. 10 shows an exemplary user interface 1000. The exemplary user interface 1000 can be rendered, for example, in response to a command from a particular user. In one example, a particular user 1001 speaks profanity within a session. In this example, a pause or lock command is received from an administrative user 1003 and the session is locked (e.g., audio and video feeds are muted, admission of additional users is suspended, etc.). Continuing this example, a command to remove the particular user 1001 is received and the session service 207 suspends the particular 1001 from the session, or the spatial field associated therewith, and prevents the user's re-admission. In another example, a command is received to lock a spatial field 1005 with which the session is associated. In this example, admission of additional users to the spatial field 1005 is suspended. A notification can be transmitted to one or more users associated with avatars within the locked session or spatial field 1005. The notification can be an automated message (e.g., indicating the locking) or can be customized, for example, based on inputs from an administrative or presenting user.

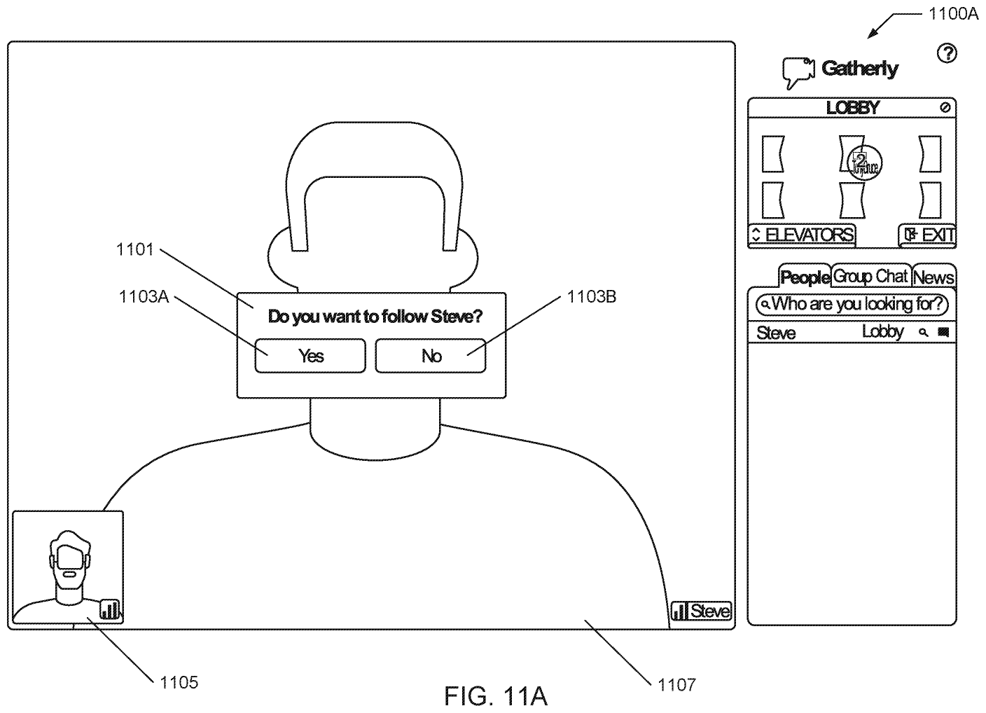

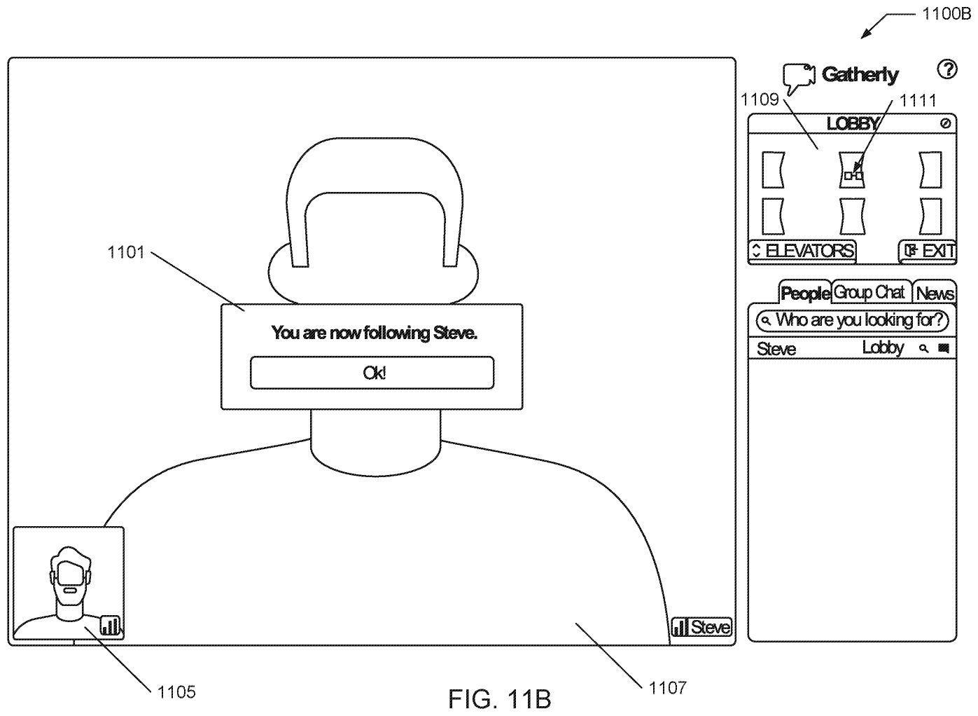

FIG. 11A shows an exemplary user interface 1100A. The user interface 1100A can be rendered, for example, in response to receiving a request to follow or subscribed to a particular user. The session service 205 can generate the user interface 110A and cause the session application 225 to render the user interface 1100A on a display 221. The user interface 1100A can include a window 1101 comprising selectable fields 1103A, 1103B by which a user can initiate a subscription command. In one example, during a session, a command can be received from a first user 1105 to follow a second user 1107. In this example, a query can be transmitted to the second user 1107, the query comprising selectable fields for approving or denying the follow action. Upon receipt of selectable field 1103A, the session service 205 can update profile information associated with a current user account to follow the user account associated with Steve.

In some embodiments, when a particular user is following a second particular user, a first avatar associated with the particular user will automatically follow a second avatar associated with the second particular user. In one embodiment, the first avatar and the second avatar may be merged together to form a new avatar. The new avatar may be the avatar of a lead user account for a group or may be an amalgamation of the avatars from the users in the group. As an example, a respective character associated with each user account in group may be presented together in the new avatar.

When a user in the group, which may be restricted to the lead user of the group, enters into a graphical representation of a session of a multi-media conference, all user account associated with the group may join the session. Similarly, when a user in the group, which may be restricted to the lead user of the group, leaves an area corresponding to the session of the multi-media conference, all users associated with the group may leave the session of the multi-media conference.

FIG. 11B shows an exemplary user interface 1100B. The user interface 1100B can be temporally subsequent and substantially similar to the user interface 1100A (FIG. 11A). The user interface 1100B can include a window 1101 in which a notification is rendered. In one example, the notification indicates the successful execution of a follow command. The user interface 1100B can include a spatial field 1109 in which indicia 1111, such as a linkage, is rendered between the avatars for which the follow command was executed.

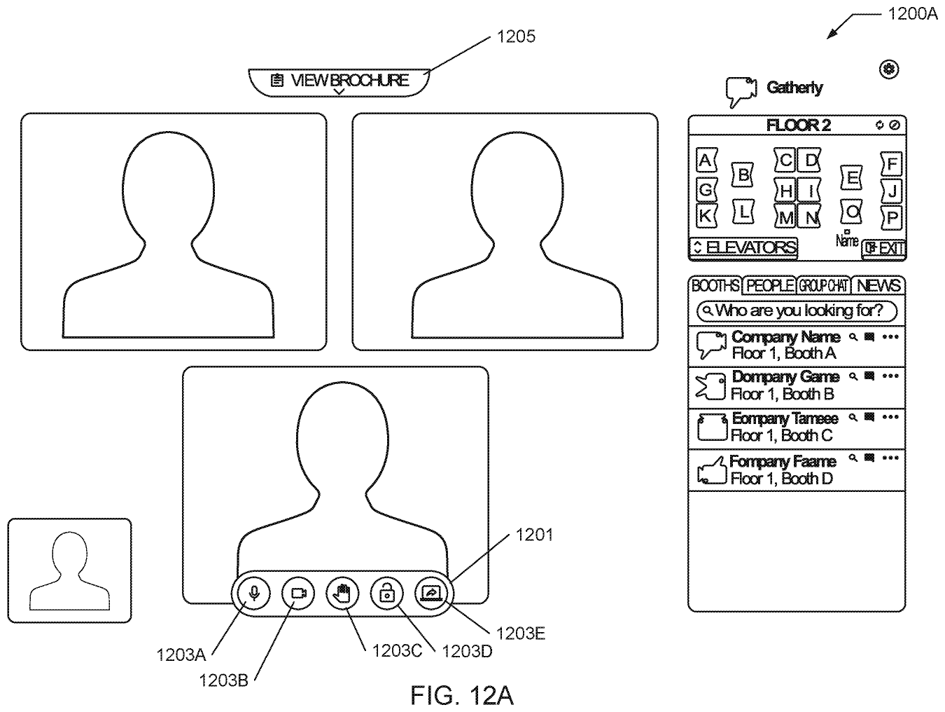

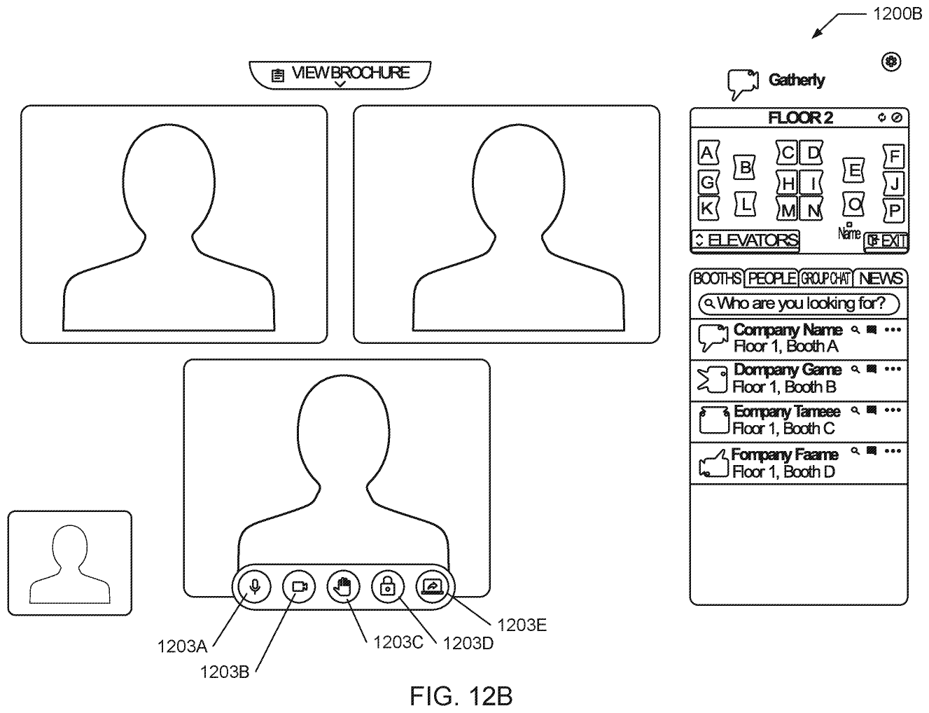

FIG. 12A shows an exemplary user interface 1200A. The user interface 1200A can include a command window 1201 in which a plurality of selectable fields 1203A-E can be rendered. Selection of a field 1203A-E can cause one or more commands to be issued, including, but not limited to, muting an audio and/or video feed, transmitting a notification to other users within a spatial field or session, locking or unlocking a session, and sharing a screen. The user interface 1200A can include a selectable multimedia field 1205. Selection of the multimedia field 1205 can cause various content to be rendered on the user interface 1200A. In one example, selection of the multimedia field 1205 causes a multimedia brochure to be rendered on the user interface 1200A. In another example, the multimedia brochure is transmitted to a computing device 203 with which the command is associated.

FIG. 12B shows an exemplary user interface 1200B. The user interface 1200B can be temporally subsequent and substantially similar to the user interface 1200B. The selectable fields 1203A-E can be updated, for example, in response to a selection. In one example, in response to a selection, the field 1203D is updated from an unlocked symbol to a locked symbol.

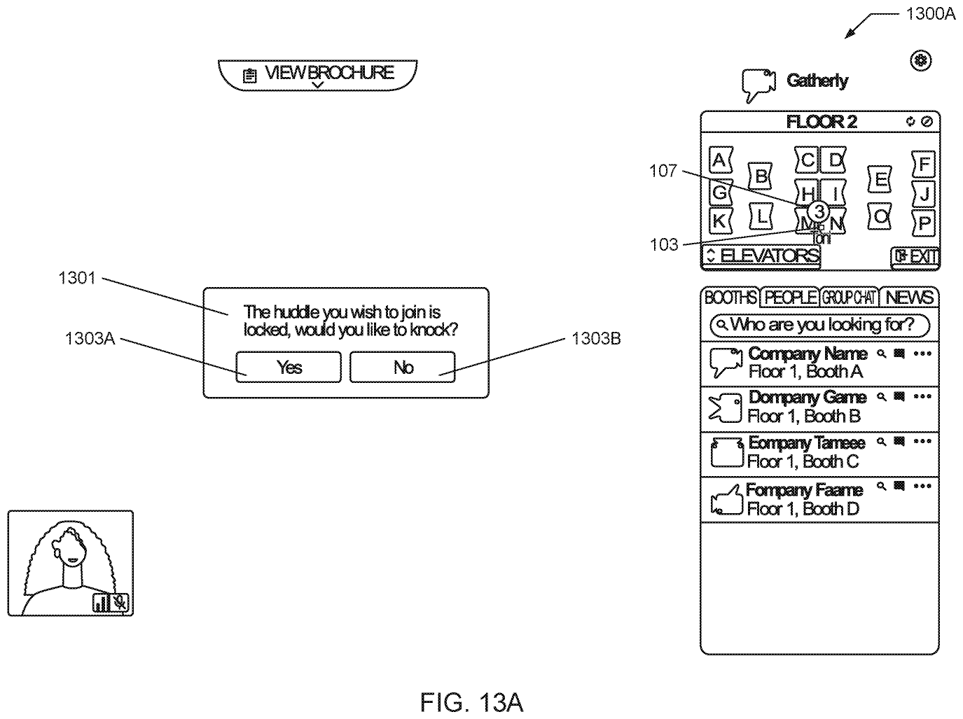

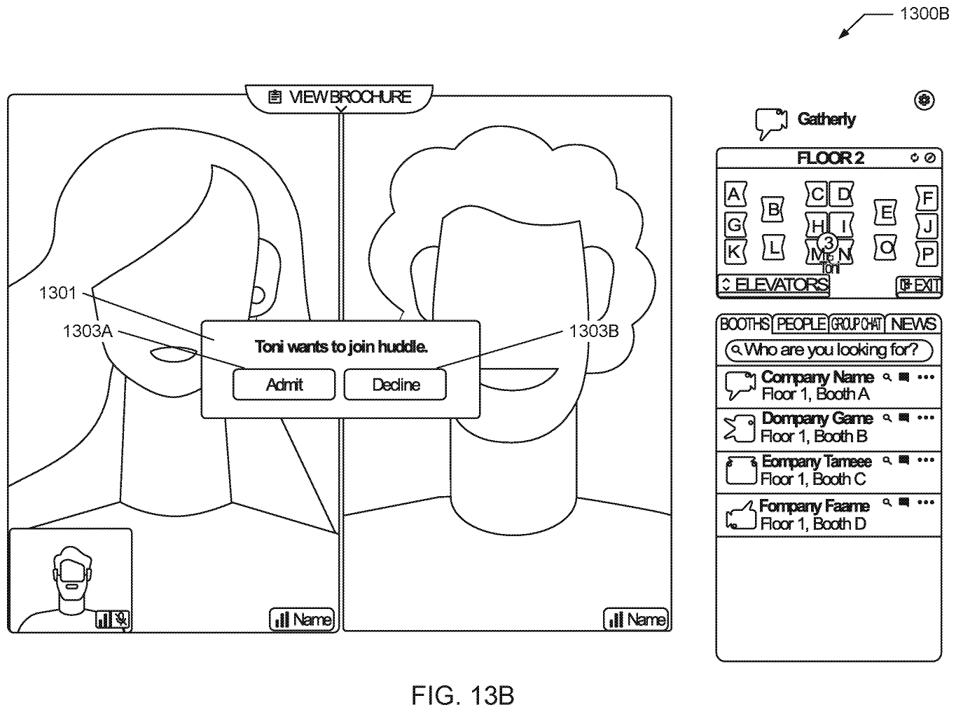

FIG. 13A shows an exemplary user interface 1300A. The user interface 1300A can be rendered, for example, in response to an avatar 103 being navigated within a predetermined proximity of a session indicator 107. The user interface 1300A can include a window 1301 in which one or more fields 1303A, 1303B can be rendered. Selection of the field 1303A or 1303B can cause a command to be initiated. In one example, the window 1301 can include fields allowing a user to request admission to a spatial field or session. In this example, selection of the field 1303A causes a command to be initiated in which a request for admission is transmitted to a participating, presenting, and/or administrative user.

FIG. 13B shows an exemplary user interface 1300B. The user interface 1300B can be rendered in response to initiation of a command comprising a request for admission to a spatial field or session. The user interface 1300B can include a window 1301 in which one or more fields 1303A, 1303B are rendered. In one example, the window 1301 includes fields allowing a user (e.g., a presenting user, administrative user, etc.) to approve or deny admission to another user. In this example, selection of the field 1303A causes the requesting user to be admitted to the corresponding spatial field or session.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

1. A system, comprising:
a data store; and
at least one computing device in communication with the data store, the at least one computing device being configured to:
receive, from a first computing device associated with a first avatar, a first request to join at least one of a plurality of two-dimensional spatial fields;
receive, from a second computing device associated with a second avatar, a second request to join the at least one of the plurality of two-dimensional spatial fields;
generate a user interface comprising a visual representation of the plurality of two-dimensional spatial fields, wherein the at least one of the plurality of spatial fields comprises the first avatar at a first current position and the second avatar at a second current position;
adjust at least one of the first current position or the second current position in response to at least one input from at least one of the first computing device and the second computing device;
determine a distance between the first current position and the second current position is less than or equal to a threshold distance; and
in response to the distance being less than or equal to, initiate a session of a multi-media conference comprising at least the first computing device and the second computing device.

2. The system of claim 1, wherein the at least one computing device is configured to:
generate the at least one of the plurality of two-dimensional spatial fields excluding the first avatar and the second avatar;
update the at least one of the plurality of spatial fields to include the first avatar responsive to the first request; and
update the at least one of the plurality of spatial fields to include the second avatar responsive to the second request.

3. The system of claim 1, wherein the at least one computing device is configured to generate a visual representation of the multi-media conference on the at least one of a plurality of two-dimensional spatial fields.

4. The system of claim 3, wherein the at least one computing device is configured to:
receive, from a third computing device associated with a third avatar, a third request to join the at least one of the plurality of two-dimensional spatial fields;
update the at least one of the plurality of two-dimensional spatial fields to include the third avatar responsive to the third request; and
in response to the third avatar moving to at least partially intersect with the visual representation of the multi-media conference on the at least one of the plurality of two-dimensional spatial fields, add the third computing device to the session of the multi-media conference with at least the first computing device and the second computing device.

5. The system of claim 3, wherein the at least one computing device is further configured to:
adjust the first current position in response to a second at least one input from the first computing device;
determine that the first current position is outside of at least a portion of the visual representation of the multi-media conference on the at least one of the plurality of two-dimensional spatial fields; and
remove the first computing device from the session of the multi-media conference.

6. The system of claim 3, wherein the visual representation comprises a first visual representation and a second visual representation, the first visual representation occupying a greater portion of the field than the second visual representation, wherein the at least one computing device is further configured to:
cause the at least one of the plurality of two-dimensional spatial fields to be rendered with the first visual representation for a first plurality of computing devices in the session of the multi-media conference; and
cause the at least one of the plurality of two-dimensional spatial fields to be rendered with the second visual representation for a second plurality of computing devices that are not in the session of the multi-media conference.

7. The system of claim 1, wherein the at least one of the plurality of two-dimensional spatial fields comprises a third avatar at a third current position and a fourth avatar at a fourth current position, the third avatar is associated with a third computing device, the fourth avatar is associated with a fourth computing device, and the at least one computing device is further configured to:
adjust at least one of the third current position or the fourth current position;
determine a second distance between the third current position and the fourth current position is less than or equal to the threshold distance; and
initiate a second multi-media conference session comprising at least the third computing device and the fourth computing device.

8. A method, comprising:
generating, via at least one computing device, a user interface comprising a visual representation of a plurality of two-dimensional spatial fields, wherein at least one of the plurality of two-dimensional spatial fields comprises a first avatar associated with a first computing device at a first current position and a second avatar associated with a second computing device at a second current position;
adjusting, via the at least one computing device, at least one of the first current position or the second current position in response to at least one input from at least one of the first computing device and the second computing device;
determining, via the at least one computing device, a distance between the first current position and the second current position is less than or equal to a threshold distance; and
initiating, via the at least one computing device, a session of a multi-media conference comprising at least the first computing device and the second computing device.

9. The method of claim 8, comprising receiving, via the at least one computing device and from the first computing device, a request to join the at least one of the plurality of two-dimensional spatial fields, wherein the first avatar is added to the at least one of the plurality of two-dimensional spatial field in response to the request.

10. (canceled)

11. The method of claim 8, wherein the distance between the first current position and the second current position comprises two-dimensional distance between two points on the at least one of the plurality of two-dimensional spatial fields.

12. (canceled)

13. The method of claim 8, further comprising:
determining, via the at least one computing device, that the first current position is outside of a threshold area associated with the multi-media conference on the at least one of the plurality of two-dimensional spatial fields;
removing, via the at least one computing device, the first computing device from the session of the multi-media conference;
determining, via the at least one computing device, that the first current position has moved within the threshold distance of a third avatar associated with a third computing device; and
initiating, via the at least one computing device, a second session of a second multi-media conference comprising at least the first computing device and the third computing device.

14. A non-transitory computer-readable medium embodying a program that, when executed by at least one computing device, causes the at least one computing device to:
generate a user interface comprising a visual representation of a plurality of two-dimensional spatial fields, wherein at least one of the plurality of two-dimensional spatial fields comprises a first avatar at a first current position and a second avatar at a second current position, where the first avatar is associated with a first computing device and the second avatar is associated with a second computing device;
adjust at least one of the first current position or the second current position in response to at least one input from at least one of the first computing device and the second computing device;
determine a proximity of the first current position and the second current position is within a proximity threshold; and
initiate a session of a multi-media conference comprising at least the first computing device and the second computing device.

15. The non-transitory computer-readable medium of claim 14, wherein the program further causes the at least one computing device to generate a broadcast multi-media conference on an area of the at least one of the plurality of two-dimensional spatial fields, wherein the broadcast multi-media conference comprises an audio feed and a video feed from a third computing device that is broadcast to a plurality of computing devices in the broadcast multi-media conference.

16. The non-transitory computer-readable medium of claim 15, wherein the area of the at least one of the plurality of two-dimensional spatial fields comprises the first current position and the second current position, and the program further causes the at least one computing device to transmit the video feed and the audio feed to at least the first computing device of the plurality of computing devices and the second computing device of the plurality of computing devices.

17. The non-transitory computer-readable medium of claim 16, wherein the session of the multi-media conference comprising at least the first computing device and the second computing device occurs at least partially concurrent with the broadcast multi-media conference.

18. The non-transitory computer-readable medium of claim 14, wherein the program further causes the at least one computing device to generate a user interface comprising the at least one of the plurality of two-dimensional spatial fields and a plurality of visual representations individually corresponding to a plurality of multi-media conferences, where each of the plurality of visual representations is located on the at least one of the plurality of two-dimensional spatial fields at a respective position.

19. The non-transitory computer-readable medium of claim 14, wherein the program further causes the at least one computing device to:
determine that a third current position of a third avatar associated with a third computing device moves to at least partially intersect with a visual representation of the multi-media conference on the at least one of the plurality of two-dimensional spatial fields;
determine that the multi-media conference is locked from accepting new participants; and
prevent the third computing device from joining the session of the multi-media conference when the third current position moves to at least partially intersect with the visual representation and the multi-media conference is locked.

20. The non-transitory computer-readable medium of claim 14, wherein the program further causes the at least one computing device to:
determine that a third current position of a third avatar associated with a third computing device moves to at least partially intersect with a visual representation of the multi-media conference on the at least one of the plurality of two-dimensional spatial fields; and
generate a signal to at least one participant of the multi-media conference requesting approval to join the multi-media conference.
